(19) United States
(12) Patent Application Publication
(10) Pub. No.: US 2026/0129189 A1
(43) Pub. Date: May 7, 2026

(54) ENCODING METHOD, DECODING METHOD, ENCODERS, DECODERS, BITSTREAM AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/440,110

(22) Filed: Jan. 5, 2026

Related U.S. Application Data
(63) Continuation of application No. PCT/CN2023/106650, filed on Jul. 10, 2023.

(51) Int. Cl. H04N 19/105; H04N 19/159; H04N 19/172; H04N 19/61

(52) U.S. Cl. CPC H04N 19/105; H04N 19/159; H04N 19/172; H04N 19/61

(57) ABSTRACT

Disclosed is a decoding method. The decoding method is applied to a decoder and includes: searching for a first collocated node of a current node in a first reference picture and searching for a second collocated node of the current node in a second reference picture according to geometry information of the current node in a current picture; and performing inter attribute prediction on the current node according to the first collocated node and the second collocated node, to obtain an attribute prediction value of the current node.

### CROSS-REFERENCE TO RELATED APPLICATION

This application is a Continuation application of International Application No. PCT/CN2023/106650 filed on Jul. 10, 2023, which is incorporated herein by reference in its entirety.

### TECHNICAL FIELD

Embodiments of the present application relate to the technical field of point cloud compression, and in particular, to an encoding method, a decoding method, an encoder, a decoder, a bitstream and a storage medium.

### BACKGROUND

In a Geometry-based Point Cloud Compression (G-PCC) encoding and decoding framework or a Video-based Point Cloud Compression (V-PCC) encoding and decoding framework provided by the Moving Picture Experts Group (MPEG), geometry information and attribute information of a point cloud are coded separately.

At present, attribute information coding mainly focuses on color information coding. In the processor of color information coding, there are two main transform manners: one is a distance-based lifting transform relying on Level of Detail (LOD) partitioning, and the other is a directly performed Region Adaptive Hierarchical Transform (RAHT).

However, in related schemes of attribute RAHT inter predictive coding, there is still a need to further improve the accuracy of inter attribute prediction.

### SUMMARY

The embodiments of the present application provide an encoding method, a decoding method, an encoder, a decoder, a bitstream and a storage medium.

The technical solutions of the embodiments of the present application may be implemented as follows.

In a first aspect, the embodiments of the present application provide a decoding method, which is applied to a decoder. The method includes: searching for a first collocated node of a current node in a first reference picture and searching for a second collocated node of the current node in a second reference picture according to geometry information of the current node in a current picture; and performing inter attribute prediction on the current node according to the first collocated node and the second collocated node, to obtain an attribute prediction value of the current node.

In a second aspect, the embodiments of the present application provide an encoding method, which is applied to an encoder. The method includes: searching for a first collocated node of a current node in a first reference picture and searching for a second collocated node of the current node in a second reference picture according to geometry information of the current node in a current picture; and performing inter attribute prediction on the current node according to the first collocated node and the second collocated node, to obtain an attribute prediction value of the current node.

In a third aspect, the embodiments of the present application provide a decoder. The decoder includes: a first searching module, configured to search for a first collocated node of a current node in a first reference picture and search for a second collocated node of the current node in a second reference picture according to geometry information of the current node in a current picture; and a first predicting module, configured to perform inter attribute prediction on the current node according to the first collocated node and the second collocated node, to obtain an attribute prediction value of the current node.

In a fourth aspect, the embodiments of the present application provide a decoder. The decoder includes a first memory and a first processor; where the first memory is configured to store a computer program executable on the first processor; and the first processor is configured to, when running the computer program, perform the decoding method as described in the embodiments of the present application.

In a fifth aspect, the embodiments of the present application provide an encoder. The encoder includes: a second searching module, configured to search for a first collocated node of a current node in a first reference picture and search for a second collocated node of the current node in a second reference picture according to geometry information of the current node in a current picture; and a second predicting module, configured to perform inter attribute prediction on the current node according to the first collocated node and the second collocated node, to obtain an attribute prediction value of the current node.

In a sixth aspect, the embodiments of the present application provide an encoder. The encoder includes a second memory and a second processor; where the second memory is configured to store a computer program executable on the second processor; and the second processor is configured to, when running the computer program, perform the encoding method as described in the embodiments of the present application.

In a seventh aspect, the embodiments of the present application provide a bitstream, where the bitstream is obtained by adopting the encoding method described in the embodiments of the present application.

In an eighth aspect, the embodiments of the present application provide a computer-readable storage medium, where the computer-readable storage medium has a computer program stored thereon, and when the computer program is executed, the encoding method described in the embodiments of the present application or the decoding method described in the embodiments of the present application is implemented.

In a ninth aspect, the embodiments of the present application provide a non-transitory computer-readable storage medium, where the non-transitory computer-readable storage medium has a computer program and a bitstream stored thereon, and the computer program, when executed by a processor, enables the processor to perform the encoding method described in the embodiments of the present application, to generate the bitstream.

### BRIEF DESCRIPTION OF THE DRAWINGS

FIG. 1A is a schematic diagram of a three-dimensional point cloud picture.

FIG. 1B is a partially enlarged diagram of a three-dimensional point cloud picture.

FIG. 2A is a schematic diagram of a point cloud picture at six viewing angles.

FIG. 2B is a schematic diagram of a data storage format corresponding to a point cloud picture.

FIG. 3 is a schematic diagram of a network architecture for point cloud encoding and decoding.

FIG. 4A is a schematic diagram of a composition framework of a G-PCC encoder.

FIG. 4B is a schematic diagram of a composition framework of a G-PCC decoder.

FIG. 5A is a schematic diagram of a low plane position in a Z-axis direction.

FIG. 5B is a schematic diagram of a high plane position in a Z-axis direction.

FIG. 6 is a schematic diagram of a node coding sequence.

FIG. 7A is a schematic diagram of planar flag information.

FIG. 7B is another schematic diagram of planar flag information.

FIG. 8 is a schematic diagram of sibling nodes of a current node.

FIG. 9 is a schematic diagram of an intersection of a laser radar and a node.

FIG. 10 is a schematic diagram of a neighborhood node at the same partitioning depth and the same coordinate.

FIG. 11A to FIG. 11C are schematic diagrams of a current node being located at a low plane position of a parent node.

FIG. 12A to FIG. 12C are schematic diagrams of a current node being located at a high plane position of a parent node.

FIG. 13 is a schematic diagram of predictive coding of planar position information of a laser radar point cloud.

FIG. 14 is a schematic diagram of infer direct coding model (IDCM) coding.

FIG. 15 is a schematic diagram of coordinate transform of a point cloud acquired by a rotating laser radar.

FIG. 16 is a schematic diagram of predictive coding in an X-axis or Y-axis direction.

FIG. 17A is a schematic diagram of predicting an angle of a Y-plane by a horizontal azimuth angle.

FIG. 17B is a schematic diagram of predicting an angle of an X-plane by a horizontal azimuth angle.

FIG. 18 is another schematic diagram of predictive coding in an X-axis or Y-axis direction.

FIG. 19A is a schematic diagram of three vertexes included in a sub-block.

FIG. 19B is a schematic diagram of approximating a triangle soup using three vertexes.

FIG. 19C is a schematic diagram of triangle soup upsampling.

FIG. 20 is a schematic diagram of a distance-based LOD construction process.

FIG. 21 is a schematic diagram of a visualization result of an LOD generation process.

FIG. 22 is a schematic diagram of a coding process for attribute prediction.

FIG. 23 is a schematic diagram of a composition of a pyramid structure.

FIG. 24 is another schematic diagram of a composition of a pyramid structure.

FIG. 25 is a schematic diagram of an LOD structure for inter-level nearest neighbor search.

FIG. 26 is a schematic structural diagram of performing a nearest neighbor search based on a spatial relationship.

FIG. 27A is a schematic diagram of a co-planar spatial relationship.

FIG. 27B is a schematic diagram of co-planar and co-edge spatial relationships.

FIG. 27C is a schematic diagram of co-planar, co-edge and co-vertex spatial relationships.

FIG. 28 is a schematic diagram of inter-level prediction based on fast search.

FIG. 29 is a schematic diagram of an LOD structure for attribute intra-level nearest neighbor search.

FIG. 30 is a schematic diagram of intra-level prediction based on fast search.

FIG. 31 is a schematic structural diagram of performing block-based neighborhood search.

FIG. 32 is a schematic diagram of a coding process of lifting transform.

FIG. 33 is a schematic structural diagram of RAHT attribute transform coding.

FIG. 34 is a schematic diagram of a RAHT transform process along x, y and z directions.

FIG. 35A is a schematic diagram of a RAHT forward transform process.

FIG. 35B is a schematic diagram of a RAHT inverse transform process.

FIG. 36 is a schematic structural diagram of an attribute coding block.

FIG. 37 is a schematic diagram of an entire process of RAHT attribute prediction transform coding.

FIG. 38 is a schematic diagram of a neighborhood prediction relationship of a current block.

FIG. 39 is a schematic diagram of a calculation process for an attribute transform coefficient.

FIG. 40 is a schematic structural diagram of RAHT attribute inter prediction coding.

FIG. 41 is a schematic flowchart of an encoding method provided by the embodiments of the present application.

FIG. 42 is a schematic diagram of a principle of bidirectional inter attribute prediction provided by the embodiments of the present application.

FIG. 43 is a schematic flowchart of a specific implementation for step 412 provided by the embodiments of the present application.

FIG. 44 is a schematic flowchart of an implementation of a decoding method provided by the embodiments of the present application.

FIG. 45 is a schematic diagram of a RAHT coding level provided by the embodiments of the present application.

FIG. 46 is a schematic structural diagram of a decoder provided by the embodiments of the present application.

FIG. 47 is a schematic structural diagram of an encoder provided by the embodiments of the present application.

FIG. 48 is a schematic structural diagram of a decoder provided by the embodiments of the present application.

FIG. 49 is a schematic structural diagram of an encoder provided by the embodiments of the present application.

### DETAILED DESCRIPTION

To provide a more detailed understanding of the features and technical contents of the embodiments of the present application, the implementations of the embodiments of the present application are described in detail below in conjunction with the accompanying drawings. The accompanying drawings are for reference and illustration only and are not intended to limit the embodiments of the present application.

Unless defined otherwise, all technical and scientific terms used herein have the same meaning as commonly understood by those skilled in the art belonging to technical field of the present disclosure. The terms used herein are only for the purpose of describing the embodiments of the present application and not intended to limit the present application.

In the following description, reference is made to “some embodiments”, which describes a subset of all possible embodiments. However, it is to be understood that “some embodiments” may be the same subset or different subsets of all possible embodiments and may be combined with each other without conflict.

It should also be noted that the terms “first\second\third” involved in the embodiments of the present application are only used to distinguish similar objects and do not represent a specific ordering for the objects. It is to be understood that the specific order or sequence of “first\second\third” may be interchanged where permitted, so that the embodiments of the present application described here can be implemented in an order other than that illustrated or described here.

A point cloud is a three-dimensional representation form of an object surface, and point cloud (data) of the object surface may be collected through acquisition devices such as a photoelectric radar, a laser radar, a laser scanner or a multi-view camera.

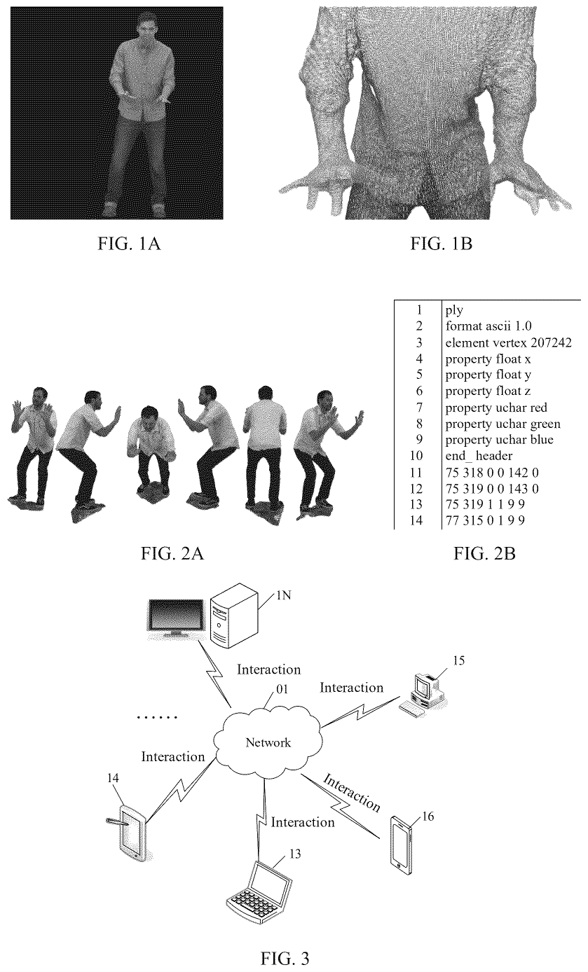

The point cloud refers to a set of discrete points in space that are irregularly distributed and express the spatial structure and surface attributes of a three-dimensional objector scenario. FIG. 1A illustrates a three-dimensional point cloud picture, and FIG. 1B illustrates a partially enlarged diagram of the three-dimensional point cloud picture. It can be seen that the point cloud surface is composed of densely distributed points.

A two-dimensional picture has information expression at each sample point (also referred to as pixel point), and the distribution is regular, so there is no need to record its position information additionally. However, the distribution of points in the point cloud is random and irregular in three-dimensional space, so it is necessary to record the position of each point in space to completely express the entire point cloud. Similar to the two-dimensional picture, during the acquisition process, each position has corresponding attribute information (RGB color values usually), and the color values reflect the color of the object. For the point cloud, in addition to color information, the attribute information corresponding to each point also commonly includes a reflectance value, and the reflectance value reflects the surface material of the object. Therefore, the point cloud data usually includes geometry information composed of three-dimensional position information and attribute information composed of three-dimensional color information and one-dimensional reflectance information. A point in the point cloud may include position information of the point and attribute information of the point. For example, the position information of the point may be three-dimensional coordinate information (x, y, z) of the point. The position information of the point may also be referred to as geometry information of the point. For example, the attribute information of the point may include color information (three-dimensional color information) and/or reflectance (one-dimensional reflectance information r), or the like. For example, the color information may be information in any color space. For example, the color information may be RGB information, where R represents red (R), G represents green (G) and B represents blue (B). For another example, the color information may be luma-chroma (YCbCr, YUV) information, where Y represents luminance (Luma), Cb (U) represents blue chromatic aberration and Cr (V) represents red chromatic aberration.

For a point cloud obtained according to the laser measurement principle, a point in the point cloud may include three-dimensional coordinate information of the point and a reflectance value of the point. For another example, for a point cloud obtained according to the photogrammetry principle, a point in the point cloud may include three-dimensional coordinate information of the point and three-dimensional color information of the point. For another example, for a point cloud obtained by combining the laser measurement principle and photogrammetry principle, a point in the point cloud may include three-dimensional coordinate information of the point, a reflectance value of the point and three-dimensional color information of the point.

FIG. 2A and FIG. 2B illustrate a point cloud picture and its corresponding data storage format, respectively. FIG. 2A provides six viewing angles of the point cloud picture, and FIG. 2B consists of a file header information part and a data part. The header information includes a data format, a data representation type, the total number of points of a cloud point and content represented by the point cloud. For example, the point cloud is in the “.ply” format, represented by ASCII codes, and has a total of 207,242 points. Each point has three-dimensional coordinate information (x, y, z) and three-dimensional color information (r, g, b).

Point clouds may be classified into the following three types according to the ways of acquisition:
a static point cloud: that is, an object is static, and a device for acquiring the point cloud is also static;
a dynamic point cloud: an object is dynamic, but a device for acquiring the point cloud is static; and
a dynamically acquired point cloud: a device for acquiring the point cloud is dynamic.

For example, point clouds may be classified into two types according to purposes:
type I: a machine perception point cloud, which may be used for scenarios such as an autonomous navigation system, a real-time inspection system, a geographic information system, a visual sorting robot, and a disaster relief robot; and
type II: a human eye perception point cloud, which may be used for point cloud application scenarios such as digital cultural heritage, free viewpoint broadcasting, 3D immersive communication, and 3D immersive interaction.

The point cloud may express the spatial structure and surface attributes of the three-dimensional object or scenario flexibly and conveniently. Moreover, since the point cloud is acquired by directly sampling the real object, the point cloud may provide a strong sense of reality under the premise of ensuring accuracy. Therefore, the point cloud is widely applied, and its applied range includes a virtual reality game, a computer-aided design, a geographic information system, an automatic navigation system, digital cultural heritage, free-viewpoint broadcasting, three-dimensional immersive remote presentation, three-dimensional reconstruction of biological tissues and organs or the like.

The collection of the point cloud mainly includes the following ways: computer generation, 3D laser scanning, 3D photogrammetry or the like. The computer may generate point clouds of virtual three-dimensional objects and scenarios; 3D laser scanning may obtain point clouds of static real-world three-dimensional objects or scenarios, and may obtain millions of point clouds per second; and 3D photogrammetry may obtain point clouds of dynamic real-world three-dimensional objects or scenarios, and may obtain tens of millions of point clouds per second. These technologies reduce the cost and time period of point cloud data acquisition and improve the accuracy of data. The change in the way for acquiring point cloud data makes it possible to acquire a large amount of point cloud data. However, with the growth of application demand, the processing of massive 3D point cloud data has encountered the bottleneck in storage space and transmission bandwidth limitation.

For example, taking a point cloud video with a frame rate of 30 frames per second (fps) as an example, the number of points of the point cloud per frame is 700,000, and each point has coordinate information xyz (float) and color information RGB (uchar); and thus, the data volume of a 10s point cloud video is approximately 0.7 million×(4 Byte×3+1 Byte×3)×30 fps×10s=3.15 GB, where 1 Byte is 8 bit. For a two-dimensional video with a YUV sampling format of 4:2:0, a resolution of 1280×720 and a frame rate of 24 fps, the data volume of a 10s video is approximately 1280×720×12 bit×24 fps×10s≈0.33 GB, and the data volume of a 10s three-dimensional video with two-viewpoints is approximately 0.33×2=0.66 GB. It can be seen that, for videos with the same duration, the data volume of point cloud video is much larger than that of two-dimensional video or that of three-dimensional video. Therefore, in order to better realize the data management, save the server storage space and reduce the transmission traffic and transmission time between the server and the client, point cloud compression has become a key issue to promote the development of the point cloud industry.

That is, since the point cloud is a collection of massive points, storing the point cloud not only consumes a lot of memory, but also causes inconvenience for transmission. Moreover, there is no such large bandwidth to support direct transmission of the point cloud at the network layer, without compression. Therefore, the point cloud needs to be compressed.

At present, a point cloud encoding framework that could perform compression on the point cloud may be a G-PCC encoding and decoding framework or a V-PCC encoding and decoding framework provided by the MPEG, or may be an audio video coding standard-PCC (AVS-PCC) encoding and decoding framework provided by the AVS. The G-PCC encoding and decoding framework may be used to perform compression on a first type of static point cloud and a third type of dynamically acquired point cloud, and the G-PCC encoding and decoding framework may be a point cloud compression-based test platform (Test Model Compression 13, TMC13). The V-PCC encoding and decoding framework may be used to perform compression on a second type of dynamic point cloud, and the V-PCC encoding and decoding framework may be a point cloud compression-based test platform (Test Model Compression 2, TMC2). Thus, the G-PCC encoding and decoding framework is also referred to as a point cloud codec (encoder/decoder) TMC13, and the V-PCC encoding and decoding framework is also referred to as a point cloud codec TMC2.

The embodiments of the present disclosure provide a network architecture of a point cloud encoding and decoding system including a decoding method and an encoding method. FIG. 3 is a schematic diagram of a network architecture of point cloud encoding and decoding provided in the embodiments of the present disclosure. As illustrated in FIG. 3, the network architecture includes one or more electronic devices 13 to 1N and a communication network 01, where the electronic devices 13 to 1N may perform video interaction through the communication network 01. During the implementation process, the electronic device may be various types of devices with point cloud encoding and decoding functions. For example, the electronic device may include a mobile phone, a tablet computer, a personal computer, a personal digital assistant, a navigator, a digital phone, a video phone, a television, a sensor device, a server, or the like, and the embodiments of the present disclosure are not limited thereto. The decoder or encoder in the embodiments of the present disclosure may be the above electronic device.

The electronic device in the embodiment of the present disclosure has point cloud encoding and decoding functions, and generally, the electronic device includes a point cloud encoder (i.e., encoder) and a point cloud decoder (i.e., decoder).

The related technology will be described below by taking the G-PCC encoding and decoding framework as an example.

It is to be understood that in the point cloud G-PCC encoding and decoding framework, for the point cloud data to be coded, the point cloud data is partitioned into multiple slices through slice partitioning firstly. In each slice, the geometry information of the point cloud and the attribute information corresponding to each point cloud are encoded separately.

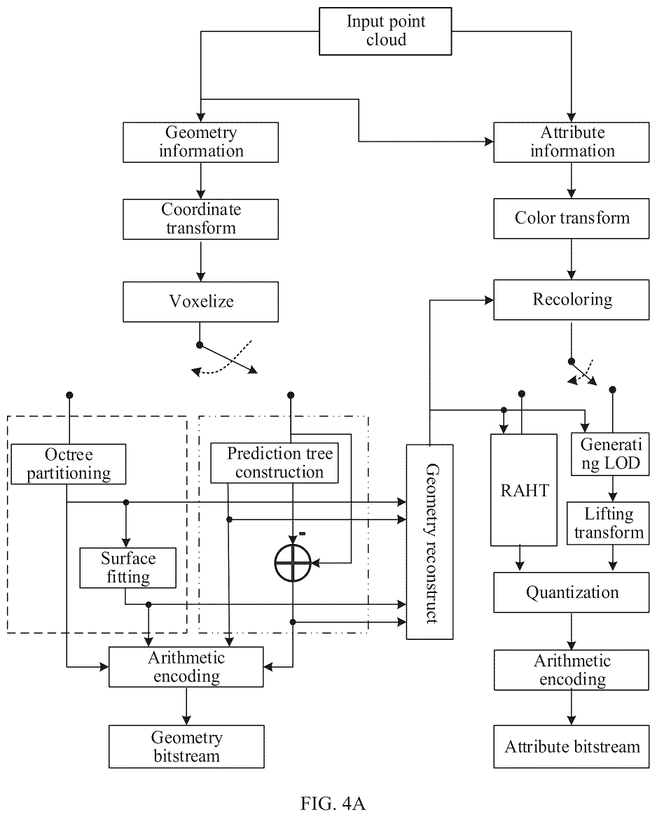

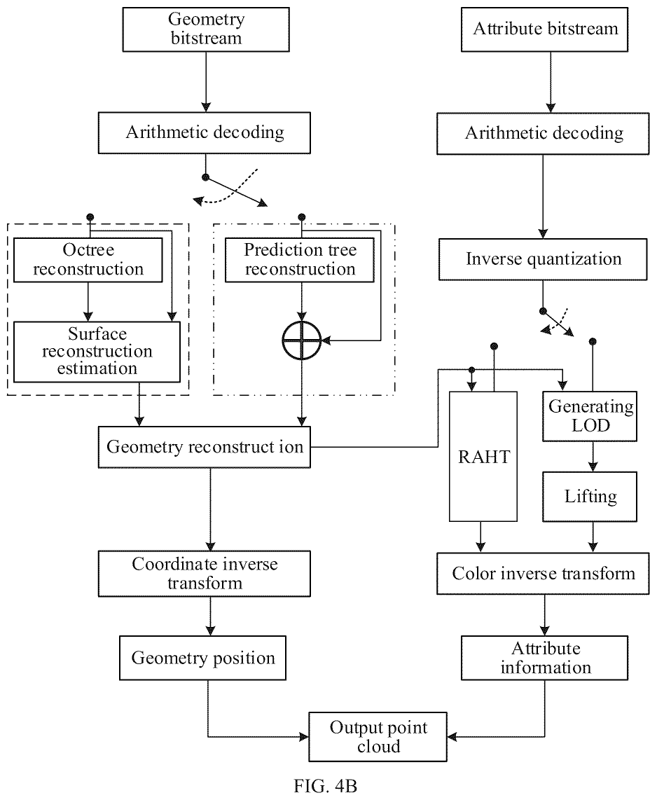

FIG. 4A illustrates a schematic diagram of a composition framework of a G-PCC encoder. As illustrated in FIG. 4A, in the geometry encoding process, coordinate transform is performed on the geometry information, so that all point clouds are included in a Bounding Box, and then, quantization is performed, where the process of quantization mainly plays the role of scaling. Due to quantization and rounding, the geometry information of part of the point clouds is the same, and it is determined whether to remove duplicate points based on the parameter. The process of quantization and removal of duplicate points is also referred to as a voxelization process. Then, octree partitioning or predictive tree construction is performed on the Bounding Box. During this process, arithmetic encoding is performed on points among the partitioned leaf nodes to generate a binary geometry bitstream; or arithmetic encoding is performed on vertexes generated by partitioning (surface fitting is performed based on the vertexes) to generate a binary geometry bitstream. In the attribute encoding process, after geometry encoding is completed and the geometry information is reconstructed, color transform is required firstly to transform the color information (i.e., attribute information) from the RGB color space to the YUV color space. Then, recoloring is performed on the point cloud using the reconstructed geometry information, to enable the unencoded attribute information to correspond to the reconstructed geometry information. Attribute encoding is mainly performed for the color information. In the process of color information encoding, there are two main transform methods: one is the distance-based lifting transform relying on LOD partitioning, and the other is the directly performed RAHT. Both methods can transform the color information from the spatial domain to the frequency domain, and obtain high-frequency coefficients and low-frequency coefficients through transform. Finally, quantization is performed on the coefficients, and next, arithmetic encoding is performed on the quantization coefficients to generate a binary attribute bitstream.

FIG. 4B illustrates a schematic diagram of a composition framework of a G-PCC decoder. As illustrated in FIG. 4B, for the acquired binary bitstreams, the geometry bitstream and the attribute bitstream in the binary bitstreams are first decoded independently. Upon decoding the geometry bitstream, the geometry information of the point cloud is obtained through arithmetic decoding, octree reconstruction/predictive tree reconstruction, geometry reconstruction and coordinate inverse conversion. Upon decoding the attribute bitstream, the attribute information of the point cloud is obtained through arithmetic decoding, inverse quantization, LOD partitioning/RAHT and color inverse conversion. The point cloud data to be coded (i.e., output point cloud) is restored based on the geometry information and attribute information.

It is to be noted that, as illustrated in FIG. 4A or FIG. 4B, the current G-PCC geometry encoding and decoding may be divided into octree-based geometry encoding and decoding (marked by a dashed box) and predictive tree-based geometry encoding and decoding (marked by a dash-dotted line box).

For the octree-based geometry encoding (Octree geometry encoding, OctGeomEnc), the OctGeomEnc includes the following. First, coordinate transform is performed on the geometry information, so that all point clouds are included in a Bounding Box. Then, quantization is performed, and the process of quantization mainly plays the role of scaling. Due to quantization and rounding, the geometry information of part of points is the same, and it is determined whether to remove duplicate points based on the parameter. The process of quantization and removal of duplicate points is also referred to as a voxelization process. Next, tree partitioning (e.g., octree, quadtree, binary tree) is performed on the Bounding Box continually in the order of breadth-first traversal, and the occupancy code of each node is encoded. A company proposed an implicit geometry partitioning method. First, the bounding box of the point cloud (2^{d}^{ₓ}, 2^{d}^{_{y}}, 2^{d}^{_{z}}) is calculated; and assuming that dₓ>d_{y}>d_{z}, the bounding box corresponds to a cuboid. During geometry partitioning, binary tree partitioning is performed first based on the x-axis to obtain two child nodes; binary tree partitioning continues until the condition of dₓ=d_{y}>d_{z} is met, and quadtree partitioning is performed continually based on the x and y axes to obtain four child nodes; and then, when the condition of dₓ=d_{y}=d_{z} is met, octree partitioning is performed continually until the leaf node obtained through partitioning is a unit cube with a size of 1×1×1, at which the partitioning operation terminates. After that, the points among the leaf nodes are encoded to generate a binary bitstream. During the process of binary tree/quadtree/octree-based partitioning, two parameters, K and M, are introduced. Parameter K indicates the maximum number of binary tree/quadtree partitionings before octree partitioning is performed; and parameter M is used to indicate that the side length of the corresponding minimum block is 2^{M} when binary tree/quadtree partitioning is performed. At the same time, K and M must meet the condition: assuming that dₘₐₓ=max(dₓ,d_{y},d_{z}), dₘᵢₙ=min(dₓ,d_{y},d_{z}), parameter K meets the condition of K≥dₘₐₓ−dₘᵢₙ; and parameter M meets the condition of M≥dₘᵢₙ. The reason why parameters K and M meet the above conditions is that, in the current process of G-PCC geometry implicit partitioning, the priority of the partitioning manners is binary tree, quadtree and octree. Only when the block size of the node does not meet the condition of binary tree/quadtree, will octree partitioning be performed on the node until the minimum unit of the partitioned leaf node has a size of 1×1×1. The octree-based geometry information encoding mode may effectively encode the geometry information of the point cloud by utilizing the correlation between adjacent points in space. However, for some relatively planar nodes or nodes with planar characteristics, the coding efficiency of the geometry information of point cloud may be further improved by utilizing the planar coding mode.

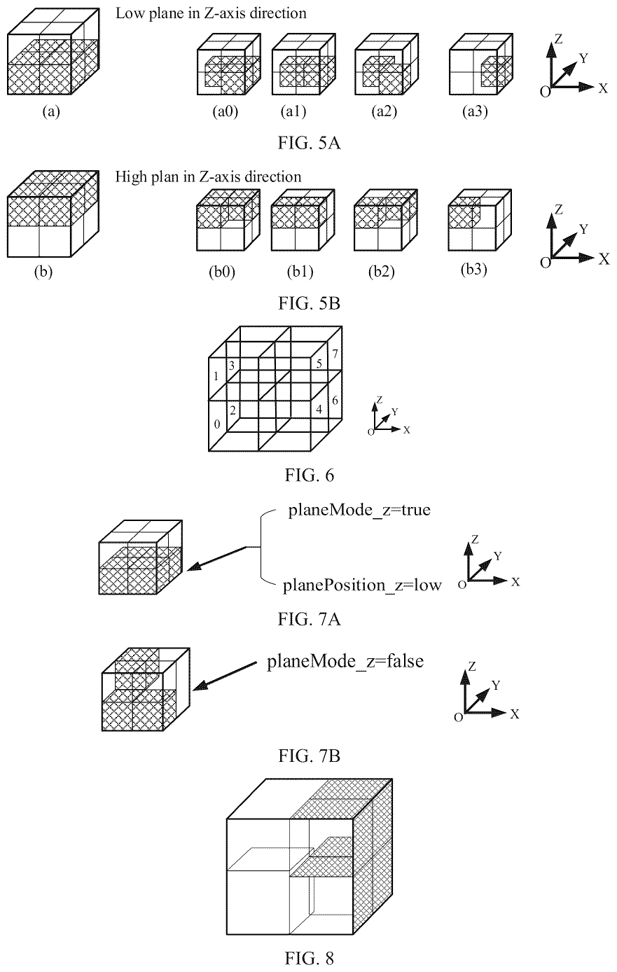

For example, FIG. 5A and FIG. 5B provide schematic diagrams of plane positions. FIG. 5A illustrates a schematic diagram of a low plane position in the Z-axis direction, and FIG. 5B illustrates a schematic diagram of a high plane position in the Z-axis direction. As illustrated in FIG. 5A, (a), (a0), (a1), (a2) and (a3) here all belong to the low plane positions in the Z-axis direction. Taking (a) as an example, it can be seen that the four occupied child nodes of the current node are all located in the low plane positions of the current node in the Z-axis direction. Therefore, it may be considered that the current node belongs to the Z plane and is a low plane in the Z-axis direction. Similarly, as illustrated in FIG. 5B, (b), (b0), (b1), (b2) and (b3) here all belong to the high plane positions in the Z-axis direction. Taking (b) as an example, it can be seen that the four occupied child nodes of the current node are located in the high plane positions of the current node in the Z-axis direction. Therefore, it may be considered that the current node belongs to the Z plane and is a high plane in the Z-axis direction.

Further, taking (a) in FIG. 5A as an example, the efficiency of octree coding and the efficiency of planar coding are compared. FIG. 6 provides a schematic diagram of a node encoding sequence, that is, encoding is performed on nodes according to the sequence of 0, 1, 2, 3, 4, 5, 6 and 7 illustrated in FIG. 6. Here, if the octree coding mode is adopted for (a) in FIG. 5A, the occupancy information of the current node is represented as: 11001100. However, if the planar coding manner is adopted, one identifier needs to be coded first to represent that the current node is a plane in the Z-axis direction; secondly, if the current node is a plane in the Z-axis direction, the plane position of the current node needs to be represented; and thirdly, only the occupancy information of the low plane node in the Z-axis direction needs to be coded (that is, the occupancy information of the four child nodes 0, 2, 4 and 6). Therefore, only 6 bits need to be coded when encoding is performed on the current node based on the planar coding mode, which can reduce representation of 2 bits compared with the octree coding in the related art. Based on the analysis, planar coding achieves a significant improvement in coding efficiency compared with octree coding. Therefore, for an occupied node, if the planar coding mode is adopted in a certain dimension, firstly, it is necessary to represent the planar flag (planarMode) and planar position (PlanePos) information of the current node in such dimension, and then, encode the occupancy information of the current node based on the planar information of the current node. For example, FIG. 7A illustrates a schematic diagram of planar flag information. As illustrated in FIG. 7A, there is a low plane in the Z-axis direction; accordingly, the value of the planar flag information is true or 1, i.e., planarMode__{z}=true; and the planar position information is low plane, i.e., PlanePosition__{z}=low. FIG. 7B illustrates another schematic diagram of planar flag information. As illustrated in FIG. 7B, there is no plane in the Z-axis direction; accordingly, the value of the planar flag information is false or 0, i.e., planarMode__{z}=false.

It is to be noted that, for planarMode_ᵢ, 0 represents that the current node is not a plane in the i-axis direction, and 1 represents that the current node is a plane in the i-axis direction. If the current node is a plane in the i-axis direction, for PlanePosition_ᵢ, 0 represents that the current node is a low plane in the i-axis direction, and 1 represents that the current node is a high plane in the i-axis direction. Where i represents the coordinate dimension, which may be the X-axis direction, the Y-axis direction or the Z-axis direction, so i=0, 1, 2.

In the G-PCC standards, it is determined whether a node meets a condition for planar coding; and when the node meets the condition for planar coding, it is necessary to perform predictive coding on the planar flag and planar position information.

In the embodiments of the present application, the current G-PCC standards have three types of determination condition for determining whether a node meets planar coding, which are described in detail below.

I. The determination is performed according to the plane probability of the node in each dimension:
(1) local region density (local_node_density) of the current node is determined; and
(2) probability Prob(i) of the current node in each dimension is determined.

When the local_node_density of the node is less than a threshold Th (e.g., Th=3), the plane probabilities of the current node in three coordinate dimensions Prob(i) are compared with thresholds Th0, Th1 and Th2, where Th0<Th1<Th2 (e.g., Th0=0.6, Th1=0.77 and Th2=0.88). Here, Eligibleᵢ (i=0, 1, 2) is used to represent whether the planar coding is enabled in each dimension, Eligibleᵢ=Prob(i)>=threshold.

It is to be noted that the thresholds are adaptively changed. For example, when

$${Eligible}_{0} = Prob ( 0 ) > = Th 0 ;$$

$${Eligible}_{1} = Prob ( 1 ) > = Th 1 ; and$$

$${Eligible}_{2} = Prob ( 2 ) > = T h 2 .$$

When Prob(1)>Prob(0)>Prob(2), the setting of Eligibleᵢ is as follows:

$${Eligible}_{0} = Prob ( 0 ) > = Th 1 ;$$

$${Eligible}_{1} = Prob ( 1 ) > = Th 0 ; and$$

$${Eligible}_{2} = Prob ( 2 ) > = T h 2 .$$

Here, Prob(i) is updated as follows:

$$Prob {( i )}_{new} = ( L \times Prob ( i ) + δ ( coded node ) ) / L + 1$$

Where L=255. In addition, if coded node is a plane, δ(coded node) is 1; otherwise, δ(coded node) is 0.

Here, local_node_density is updated as follows:

$$local\_node {\_density}_{new} = local\_node \_density + {4}^{*} numSiblings$$

Where local_node_density is initialized to 4, and numSiblings is the number of sibling nodes of the node. For example, FIG. 8 illustrates a schematic diagram of sibling nodes of a current node. As illustrated in FIG. 8, the current node is a node filled with diagonal lines, the nodes filled with grids are sibling nodes, so the number of sibling nodes of the current node is 5 (including the current node itself).

II. It is determined whether nodes in the current level meet planar coding according to point cloud density of the current level.

The density of points in the current level (or referred to as layer) is used to determine whether to perform planar coding on the nodes in the current level. Assuming that the number of points in the current to-be-encoded point cloud is pointCount, and the number of points reconstructed after IDCM encoding is numPointCountRecon. Because octree coding is performed based on the order of breadth-first traversal, the number of nodes to be coded in the current level is assumed to be nodeCount; and then the determination of whether planar coding is enabled on the current level is assumed to be planarEligibleKOctreeDepth. Specifically, planarEligibleKOctreeDepth=(pointCount−numPointCountRecon)<nodeCount×1.3.

If (pointCount−numPointCountRecon) is less than nodeCount×1.3, planarEligibleKOctreeDepthis true; and if (pointCount−numPointCountRecon) is not less than nodeCount×1.3, planarEligibleKOctreeDepth is false. In this way, when planarEligibleKOctreeDepth is true, planar coding is performed on all nodes in the current level; otherwise, planar coding is not performed on all nodes in the current level, and octree coding is adopted only.

III. It is determined whether the current node meets planar coding according to acquisition parameters of a laser radar point cloud.

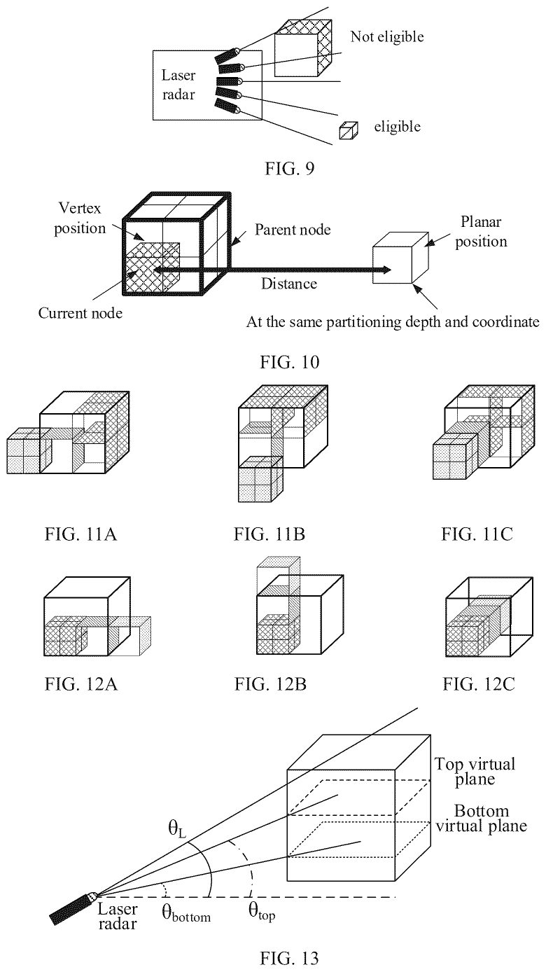

FIG. 9 illustrates a schematic diagram of an intersection of a laser radar and a node. As illustrated in FIG. 9, the node filled with grids is passed through by two lasers simultaneously, so the current node is not a plane in the Z axis vertical direction. The node filled with diagonal lines is sufficiently small such that the node cannot be passed through by two lasers simultaneously, so the node filled with diagonal lines may be a plane in the Z axis vertical direction.

Furthermore, for a node meeting the condition for planar coding, predictive coding may be performed on the planar flag information and the planar position information.

First, predictive coding is performed on the planar flag information.

Here, only three pieces of context information are adopted for coding, that is, context design for the planar flag in each coordinate dimension is performed separately.

Secondly, predictive coding is performed on the planar position information.

It is to be understood that, for coding of plane position information of a non-laser radar point cloud, predictive coding for the planar position information may include:
(a) planar position information of the current node obtained by using occupancy information of neighborhood nodes for prediction, the planar position information being three elements: predicted as a low plane, predicted as a high plane, or unpredictable;
(b) a spatial distance between a node at the same partitioning depth and the same coordinate as the current node and the current node: “near” or “far”;
(c) if a node at the same partitioning depth and the same coordinate as the current node is a plane, the plane position of the node being determined; and
(d) coordinate dimension (i=0, 1, 2).

It is to be noted that in the embodiments of the present application, after determining the spatial distance between the node at the same partitioning depth and the same coordinate as the current node and the current node, if the spatial distance is less than a preset distance threshold, then the spatial distance may be determined to be “near”; or, if the spatial distance is greater than the preset distance threshold, then the spatial distance may be determined to be “far”.

For example, FIG. 10 illustrates a schematic diagram of a neighborhood node at the same partitioning depth and the same coordinate. As illustrated in FIG. 10, a large bold cube represents a parent node, a small cube filled with grids inside represents a current node, and a vertex position of the current node is illustrated; a small cube filled with white represents a neighborhood node at the same partitioning depth and the same coordinate, a distance between the current node and the neighborhood node is the spatial distance, which may be determined as “near” or “far”. In addition, if the neighborhood node is a plane, the planar position of the neighborhood node is also needed.

In this way, as illustrated in FIG. 10, the current node is the small cube filled with grids, and the neighborhood node is searched as the small cube filled with white at the same octree partitioning depth level and the same vertical coordinate, the distance between the two nodes is determined as “near” or “far”, and reference to the planar position of the node is made.

Further, in the embodiments of the present application, FIG. 11A to FIG. 11C illustrate schematic diagrams of a current node being located at a low plane position of a parent node. FIG. 11A to FIG. 11C illustrate three examples in which the current node is located at the low plane position of the parent node. The specific instructions are as follows.

\textcircled{1}: If any one of child nodes 4 to 7 of a node filled with points is occupied, and all nodes filled with grids are not occupied, there is a high probability that there is a plane in the current node (filled with diagonal lines), and the plane position is located lower.

\textcircled{2}: If none of the child nodes 4 to 7 of the node filled with points is occupied, and any node filled with grids is occupied, there is a high probability that there is a plane in the current node (filled with diagonal lines), and the plane position is located higher.

\textcircled{3}: If all the child nodes 4 to 7 of the node filled with points are empty nodes, and all the nodes filled with grids are empty nodes, the plane position cannot be inferred and is therefore marked as unknown.

\textcircled{4}: If any one of the child nodes 4 to 7 of the node filled with points is occupied, and any one of the nodes filled with grids is occupied, the plane position still cannot be inferred and is therefore marked as unknown.

In the embodiments of the present disclosure, FIG. 12A to FIG. 12C illustrate schematic diagrams of a current node being located at a high plane position of a parent node. FIG. 11A to FIG. 11C illustrate three examples in which the current node is located at the high plane position of the parent node. The specific instructions are as follows.

\textcircled{1}: If any one of child nodes 4 to 7 of a node filled with grids is occupied, and a node filled with points is not occupied, there is a high probability that there is a plane in the current node (filled with diagonal lines), and the plane position is located lower.

\textcircled{2}: If none of the child nodes 4 to 7 of the node filled with grids is occupied, and the node filled with points is occupied, there is a high probability that there is a plane in the current node (filled with diagonal lines), and the plane position is located higher.

\textcircled{3}: If all the child nodes 4 to 7 of the node filled with grids are not occupied, and the node filled with points is not occupied, the plane position cannot be inferred and is therefore marked as unknown.

\textcircled{4}: If any one of the child nodes 4 to 7 of the node filled with grids is occupied, and the node filled with points is occupied, the plane position cannot be inferred and is therefore marked as unknown.

It is also to be understood that for coding of the planar position information of the laser radar point cloud, FIG. 13 illustrates a schematic diagram of predictive coding of planar position information of a laser radar point cloud. As illustrated in FIG. 13, when the emission angle of the laser radar is θ_{bottom}, the node may be mapped as a bottom virtual plane; and when the emission angle of the laser radar is θₜₒₚ, the node may be mapped as a top virtual plane.

That is, the plane position of the current node is predicted by using the laser radar acquisition parameters, and the position is quantified into multiple intervals by using the position where the current node intersects with the laser ray, and finally serves as the context information of the plane position of the current node. The specific calculation process is as follows: assuming that the coordinates of the laser radar are (x_{Lidar}, y_{Lidar}, z_{Lidar}), and the geometry coordinates of the current node are (x, y, z), then a vertical tangent value tan θ of the current node relative to the laser radar is calculated firstly. The calculation formula is as follows:

$$tan θ = \frac{z - {z}_{Lidar}}{\sqrt{{( x - {x}_{Lidar} )}^{2} + {( y - {y}_{Lidar} )}^{2}}}$$

Further, since each Laser has a certain offset angle relative to the laser radar, it is further necessary to calculate a relative tangent value tan θ_{corr, L} of the current node relative to the Laser. The specific calculation is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r}$$

Finally, prediction is performed on the plane position of the current node by using the relative tangent value tan θ_{corr, L} of the current node. Specifically, assuming that a tangent value of a lower boundary of the current node is tan(θ_{bottom}), and a tangent value of a top boundary is tan(θₜₒₚ), the plane position is quantized into 4 quantization intervals according to tan θ_{corr, L}, that is, the context information of the plane position is determined.

However, the octree-based geometry information coding mode has an efficient compression rate only for points with correlation in space, while for points in isolated positions in the geometry space, the complexity may be significantly reduced by using the direct coding model (DCM). For all nodes in the octree, the use of DCM is not represented by flag bit information, but inferred through the parent node and neighbor information of the current node. There are three ways to determine whether the current node is eligible for DCM encoding, and details are as follows.

(1) The current node has no sibling child nodes, that is, the parent node of the current node has only one child node, and the parent node of the parent node of the current node has only two occupied child nodes, that is, the current node has one neighboring node at most.

(2) The parent node of the current node has only one occupied child node (i.e., the current node); and the six neighboring nodes that share a face with the current node are also empty nodes.

(3) The number of sibling nodes of the current node is greater than 1.

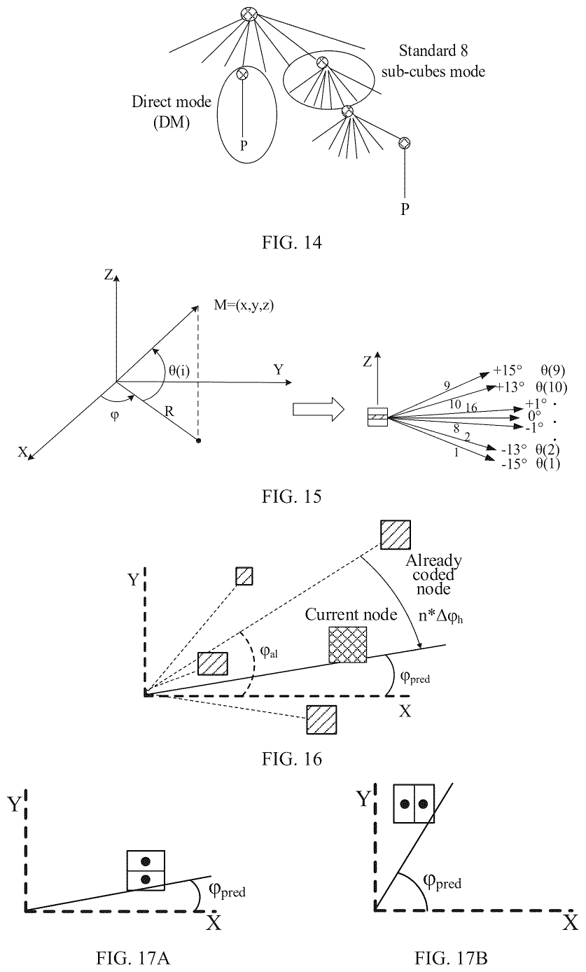

For example, FIG. 14 provides a schematic diagram of IDCM coding. If the current node is not eligible for DCM coding, octree partitioning will be performed on the current node. If the current node is eligible for DCM coding, the number of points included in the node will be further determined. When the number of points is less than a threshold (e.g., 2), DCM coding will be performed on the node, otherwise, octree partitioning will continue to be performed on the node. When the DCM coding mode is applied, it is necessary to encode whether the current node is a real isolated point firstly, that is, IDCM_flag. When IDCM_flag is true, the current node adopts DCM coding, otherwise, it still adopts octree coding. When the current node meets the condition for DCM coding, it is necessary to encode the DCM coding mode of the current node. At present, there are two DCM modes, which are: (a) existing only one point (or multiple points, but they are duplicate points); and (b) containing two points. Finally, it is necessary to encode the geometry information of each point. Assuming that a side length of the node is 2^{d}, d bits are required to encode each component of the geometry coordinates of the node, and this bit information is directly encoded into the bitstream. It is to be noted here that when encoding is performed on the laser lidar point cloud, predictive coding is performed on the coordinate information of three dimensions by using the laser lidar acquisition parameters, thereby further improving the coding efficiency of the geometry information.

Further, IDCM coding process is described in detail below.

When the current node meets the condition for DCM coding mode, the number of points (i.e., numPoints) in the current node is encoded firstly; and the number of points in the current node is encoded according to different DirectModes:
If the current node does not meet the requirements for the DCM node, it will exit directly (that is, the number of points is greater than 2, and the points are not duplicate points).
If the number of points included in the current node (i.e., numPonts) is less than or equal to 2, the encoding process is as follows:
   1) encode whether the numPonts in the current node is greater than 1 first; and
   2) if the current node has only one point and the geometry encoding environment is geometry lossless encoding, it is necessary to encode that the second point of the current node is not a duplicate point.
If the number of points included in the current node (i.e., numPonts) is greater than 2, the encoding process is as follows:
   1) encode that the numPonts in the current node is less than or equal to 1 first; and
   2) secondly, encode that the second point of the current node is a duplicate point; thirdly, encode whether the number of duplicate points of the current node is greater than 1, and when the number of duplicate points is greater than 1, it is necessary to exponential-Golomb-decode the remaining number of duplicate points.

After encoding of the number of points in the current node is completed, the coordinate information of the points included in the current node is encoded. The laser radar point cloud and the human eye-oriented point cloud are introduced in detail below, respectively.

### (I) Human Eye-Oriented Point Cloud

(1) If the current node includes only one point, the geometry information of the three-dimensional directions of the point will be encoded directly (Bypass coding).

(2) If the current node includes two points, a priority-coded coordinate axis dirextAxis is obtained first by using geometry coordinates of the points. It should be noted here that the coordinate axes currently compared only include the x-axis and y-axis, not the z-axis. Assuming that the geometry coordinate of the current node is nodePos, the determination method is as follows:

$$dirextAxis = ! ( nodePos [ 0 ] < nodePos [ 1 ] )$$

That is, an axis with the smaller node coordinate geometric position is selected as the priority-coded coordinate axis dirextAxis, and then encoding is performed on the geometry information of the priority-coded coordinate axis dirextAxis first according to the following way. Assuming that a geometry bit depth to be coded corresponding to the priority-coded coordinate axis is nodeSizeLog2 and assuming that coordinates of the two points are pointPos[0] and pointPos[1], respectively, the specific encoding process is as follows:

```
  Bool sameBit=true;
  while(nodeSizeLog2&& sameBit){
    int mask=1 << nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits); ///<entropy coding
    if(sameBits)
      encodePosBit(bit0);///<Bypass coding
    }
```

After the encoding of the priority-coded coordinate axis dirextAxis is completed, Bypass coding continues to be performed on the geometry coordinate of the current node. Assuming that the remaining coding bit depth of each point is nodeSizeLog2, the specific encoding process is as follows:

$$for ( int axisIdx = 0 ; axisIdx < 3 ; ++ axisIdx ) for ( int mask = ( 1 ≪ nodeSizeLog 2 [ axisIdx ] ) ≫ 1 ; mask ; mask ≫ 1 ) encodePosBit ( ! ! ( pointPos [ axisIdx ] \& mask ) ) .$$

### (II) Laser Radar-Oriented Point Cloud

If the current node includes two points, a priority-coded coordinate axis dirextAxis is obtained first by using the geometry coordinates of the points. Assuming that the geometry coordinate of the current node is nodePos, the determination method is as follows:

$$dirextAxis = ! ( nodePos [ 0 ] < nodePos [ 1 ] )$$

That is, an axis with the smaller node coordinate geometric position is selected as the priority-coded coordinate axis dirextAxis. It should be noted here that the coordinate axes currently compared only include the x-axis and y-axis, not the z-axis. Secondly, encoding is performed on the geometry information of the priority-coded coordinate axis dirextAxis firstly according to the following way. Assuming that a geometry bit depth to be coded corresponding to the priority-coded coordinate axis is nodeSizeLog2 and assuming that coordinates of the two points are pointPos[0] and pointPos[1], respectively, the specific encoding process is as follows:

```
  Bool sameBit=true;
  while(nodeSizeLog2&& sameBit){
    int mask=1 << nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits);
    if(sameBits)
      encodePosBit(bit0);
    }
```

After the encoding of the priority-coded coordinate axis dirextAxis is completed, encoding is performed on the geometry coordinate of the current node.

Since the acquisition parameters of the laser radar point cloud may be obtained, which could be used to predict the geometry coordinate information of the current node, thereby further improving the coding efficiency of the geometry information of the point cloud. Similarly, first, a main axis direction of Bypass coding is obtained by using the geometry information of the current node (i.e., nodePos), and then predictive coding is performed on the geometry information of another dimension by using the geometry information of the direction encoded. Also assuming that an axis direction of Bypass coding is directAxis and assuming that a bit depth to be coded in Bypass coding is nodeSizeLog2, the encoding method is as follows:

$$for ( int mask = ( 1 ≪ nodeSizeLog 2 ) ≫ 1 ; mask ; mask ≫ 1 ) encodePosBit ( ! ! ( pointPos [ directAxis ] \& mask ) ) .$$

It should be noted here that all geometry accuracy information in the directAxis direction will be encoded.

For example, FIG. 15 provides a schematic diagram of coordinate transform of a point cloud acquired by a rotating laser radar. In the Cartesian coordinate system, the (x, y, z) coordinates of each node may be converted into (R, φ, i) for representation. In addition, the laser scanner may perform laser scanning at a preset angle, and different θ(i) may be obtained under different values of i. For example, when i is equal to 1, θ(1) may be obtained and the corresponding scanning angle is −15°; when i is equal to 2, θ(2) may be obtained and the corresponding scanning angle is −13°; when i is equal to 10, θ(10) may be obtained and the corresponding scanning angle is +13°; and when i is equal to 9, θ(9) may be obtained and the corresponding scanning angle is +15°.

In this way, after the encoding of all accuracy information in directAxis coordinate direction is completed, LaserIdx corresponding to the current point (i.e., the pointLaserIdx number in FIG. 15) is calculated first, and LaserIdx of the current node (that is, nodeLaserIdx) is calculated. Secondly, predictive coding is performed on LaserIdx of the point (i.e., pointLaserIdx) by using LaserIdx of the node (i.e., nodeLaserIdx), where the calculation manner of LaserIdx of the node or point is as follows. Assuming that the geometry coordinate of the point is pointPos and the starting coordinate of the laser ray is LidarOrigin, and assuming that the number of lasers is LaserNum, the tangent value of each laser is tan θ₁, and the offset position of each laser in the vertical direction is Zᵢ, then:

```
    Int bestLaserIdx=0;
    Int Distoration=INT_MAX;
  For(int LaserIdx=0; LaserIdx<numLaser;++ LaserIdx){
$int radius = \sqrt{( pointPos [ 0 ] - LidarOrigin [ 0 ] 2 + ( pointPos [ 1 ] - LidarOrigin [ 1 ] ) 2}$
    int invRadius=1/ radius
    int Z-pointPos[2]+ Zᵢ
    int tanTheta = Z×invRadius
    if(std::abs(tanTheta-tanθᵢ)< Distoration){
    Distoration= std::abs(tanTheta-tanθᵢ);
    bestLaserIdx= LaserIdx;
  }
}
```

After LaserIdx of the current point is calculated, predictive coding is firstly performed on pointLaserIdx of the point using LaserIdx of the current node. After the encoding of LaserIdx of the current point is completed, predictive coding is performed on the geometry information of the current point in three dimensions using the acquisition parameters of the laser radar.

For example, FIG. 16 illustrates a schematic diagram of predictive coding in an X-axis or Y-axis direction. As illustrated in FIG. 16, a box filled with grids represents the current node, and a box filled with diagonal lines represents an already coded node. Here, first, the prediction value (i.e., φ_{pred}) corresponding to the horizontal azimuth angle is obtained using LaserIdx corresponding to the current point; secondly, the horizontal azimuth angle φ_{node} corresponding to the node is obtained using the node geometry information corresponding to the current point. Assuming that the geometry coordinate of the node is nodePos, the calculation manner between the horizontal azimuth angle φ and the node geometry information is as follows:

$$φ = arctan ( \frac{nodePos [ 1 ]}{nodePos [ 0 ]} )$$

By using the acquisition parameters of the laser radar, the number of rotational points (i.e., numPoints) of each laser may be obtained, and numPoints represents the number of points obtained by each laser ray rotating one full circle. Then, the number of rotational points of each laser may be used to calculate the rotational angular velocity deltaPhi of each laser. The calculation manner is as follows:

$$deltaPhi = \frac{2 π}{n u m P o i n t s}$$

Further, the prediction value of the horizontal azimuth angle φ_{predPoint} corresponding to the current point, (that is, the prediction value of the horizontal azimuth angle as illustrated in FIGS. 17A and 17B) is calculated by using the horizontal azimuth angle φ_{node} of the node and the horizontal azimuth angle φ_{pred} of the previous coded point of the laser corresponding to the current point, that is, the prediction value of the horizontal azimuth angle as illustrated in FIGS. 17A and 17B. FIG. 17A illustrates a schematic diagram of predicting an angle of a Y-plane by a horizontal azimuth angle, and FIG. 17B illustrates a schematic diagram of predicting an angle of an X-plane by a horizontal azimuth angle. Here, the prediction value of the horizontal azimuth angle φ_{predPoint} corresponding to the current point is calculated as follows:

$${φ}_{predPoint} = \frac{φ pred - φ node}{deltaPhi} \times deltaPhi + φ pred$$

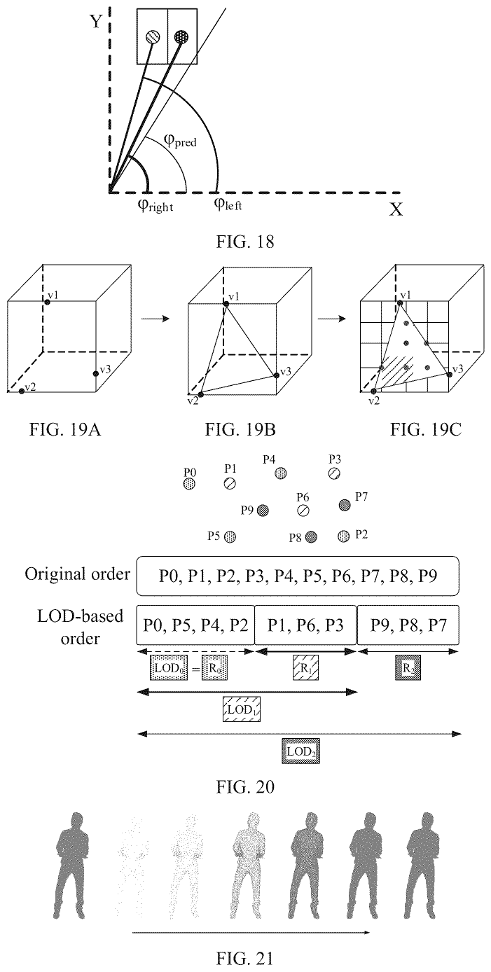

For example, FIG. 18 illustrates another schematic diagram of predictive coding in an X-axis or Y-axis direction. As illustrated in FIG. 18, apart filled with grids (left side) represents the low plane, a part filled with points (right side) represents the high plane, φ_{left} represents a horizontal azimuth angle of the low plane of the current node, φ_{right} represents a horizontal azimuth angle of the high plane of the current node, and φ_{pred} represents a prediction value of the horizontal azimuth angle corresponding to the current node.

In this way, predictive coding is performed on the geometry information of the current node by using the prediction value of the horizontal azimuth angle φ_{predPoint} and the horizontal azimuth angle of the low plane φ_{left} of the current node and the horizontal azimuth angle of the high plane φ_{right} of the current node. The details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) ‖ ( angLel < 0 \&\& angLeR < 0 ) ? 0 : 2 ;$$

$$int minAngle = std ∷ min ( abs ( angLel ) , abs ( angLeR ) ) ;$$

$$int maxAngle = std ∷ max ( abs ( angLel ) , abs ( angLeR ) ) ;$$

$$context += maxAngle > minAngle ? 0 : 1 ;$$

$$context += maxAngle > minAngle ? 0 : 4.$$

After the encoding of LaserIdx of the point is completed, predictive coding is performed on the Z-axis direction of the current point using LaserIdx corresponding to the current point. That is, depth information (radius) of the radar coordinate system is calculated by using x and y information of the current point. Then, a tangent value of the current point and an offset in the vertical direction of the current point are obtained by using the laser of the current point (LaserIdx), so that the prediction value of the current point in the Z-axis direction (that is, Z_pred) may be obtained. The details are as follows:

$$int radius = \sqrt{{( pointPos [ 0 ] - LidarOrigin [ 0 ] )}^{2} + {( pointPos [ 1 ] - LidarOrigin [ 1 ] )}^{2}} ;$$

$$int tan Theta = tan {θ}_{laserIdx} ;$$

$$int zOffset = {Z}_{laserIdx} ;$$

$$Z\_pred = radius \times tan Theta - zOffset .$$

Further, predictive coding is performed on the geometry information of the current point in the Z-axis direction by using Z_pred, to obtain a prediction residual Z_res, and finally, encoding is performed on Z_res.

It is also to be noted that when a node is partitioned into leaf nodes, under geometry lossless encoding, the number of duplicate points among the leaf nodes needs to be coded. Finally, encoding is performed on the occupancy information of all nodes to generate a binary bitstream. In addition, at present, a planar coding mode is introduced in G-PCC. In the process of geometric partitioning, it is determined whether the child nodes of the current node are located in the same plane. If the child nodes of the current node meet the coplanarity condition, the child nodes of the current node will be represented by this plane.

For octree-based geometry decoding, before decoding the occupancy information of each node in the order of breadth-first traversal, the decoding side first determines whether to perform planar decoding or IDCM decoding on the current node by using the reconstructed geometry information. If the current node meets the condition for planar decoding, the planar flag and planar position information of the current node are decoded first, and then the occupancy information of the current node is decoded based on the plane information. If the current node meets the condition for IDCM decoding, the decoding side first decodes whether the current node is a true IDCM node. If it is a true IDCM node, the decoding side continues to parse the DCM decoding mode of the current node, then the decoding side may obtain the number of points in the current DCM node; and finally, the decoding side decodes the geometry information of each point. For a node that does not meet either the condition for planar decoding or the condition for DCM decoding, the occupancy information of the current node is decoded. By continuously parsing in this way, the occupancy code of each node is obtained, and the nodes are partitioned in sequence until a unit cube with a size of 1×1×1 is obtained through partitioning, at which the partitioning operation terminates. The number of points included in each leaf node is obtained by parsing; and finally, the geometrically reconstructed point cloud information is restored.

The IDCM decoding process is introduced in detail below.

Similar to the processing procedure at the encoding side, prior information is used to determine whether a node should initiate IDCM. The initiation conditions for IDCM are as follows.

(1) The current node has no sibling child nodes, that is, the parent node of the current node has only one child node, and the parent node of the parent node of the current node has only two occupied child nodes, that is, the current node has one neighboring node at most.

(2) The parent node of the current node has only one occupied child node (i.e., the current node); and the six neighboring nodes that share a face with the current node are also empty nodes.

(3) The number of sibling nodes of the current node is greater than 1.

Further, when the node meets the condition for DCM coding, whether the current node is a true DCM node is first decoded, that is, IDCM_flag. When IDCM_flag is true, the current node adopts DCM coding, otherwise, it still adopts octree coding.

Next, the number of points (i.e., numPoints) in the current node is decoded. The specific decoding manner is as follows:
i) whether the numPonts in the current node is greater than 1 is first decoded;
ii) if the numPonts in the current node obtained by decoding is greater than 1, whether the second point is a duplicate point continues to be decoded; and if the second point is not a duplicate point, it may be implicitly inferred that the second type of DCM mode is met, i.e., including only two points; and
iii) If the numPonts in the current node obtained by decoding is less than or equal to 1, whether the second point is a duplicate point continues to be decoded; if the second point is not a duplicate point, then it may be implicitly inferred that the second type of DCM mode is met, i.e., including only one point; and if the second point obtained by decoding is a duplicate point, it may be inferred that the third type of DCM mode is met, i.e., including multiple points but the multiple points all duplicate points, then whether the number of duplicate points is greater than 1 continues to be decoded (entropy decoding), and if the number is greater than 1, the number of remaining duplicate points continues to be decoded (using exponential-Golomb decoding).

If the current node does not meet the requirements for the DCM node, it will exit directly (that is, the number of points is greater than 2, and the points are not duplicate points).

After decoding of the number of points in the current node is completed, the coordinate information of the points included in the current node is decoded. The laser radar point cloud and the human eye-oriented point cloud are introduced in detail below, respectively.

### (I) Human Eye-Oriented Point Cloud.

(1) If the current node includes only one point, the geometry information of the three-dimensional directions of the point will be decoded directly (Bypass coding).

(2) If the current node includes two points, a priority-decoded coordinate axis dirextAxis is obtained first by using geometry coordinates of the points. It should be noted here that the coordinate axes currently compared only include the x-axis and y-axis, not the z-axis. Assuming that the geometry coordinate of the current node is nodePos, the determination method is as follows:

$$dirextAxis = ! ( nodePos [ 0 ] < nodePos [ 1 ] )$$

That is, an axis with the smaller node coordinate geometric position is selected as the priority-decoded coordinate axis dirextAxis, and then decoding is performed on the geometry information of the priority-decoded coordinate axis dirextAxis firstly according to the following way. Assuming that a geometry bit depth to be decoded corresponding to the priority-decoded coordinate axis is nodeSizeLog2 and assuming that coordinates of the two points are pointPos[0] and pointPos[1], respectively, the specific decoding process is as follows:

```
Bool sameBit=true;
while(nodeSizeLog2&& sameBit){
  pointPos[0][ dirextAxis]<<1;
  pointPos[1][ dirextAxis]<<1;
  −−nodeSizeLog2;
    int bit=0;
      deEntropyCodeSameBit(sameBits); ///<entropy coding
    if(sameBits){
      bit =decodePosBit( );///<Bypass coding
      pointPos[0][ dirextAxis]|= bit
      pointPos[1][ dirextAxis]|= bit
    }else
      pointPos[1][dirextAxis]|= 1///<The reason here is that when
    encoding, the two points are sorted in the direction of the priority-coded
    axis, so pointPos[0][dirextAxis]<pointPos[1][dirextAxis] can be
    ensured. Therefore, when decoding, if bit information of the two points
    is different, it can be inferred that the bit of the first point is 0 and the bit
    of the second point is 1.
    }
```

After the decoding of the priority-decoded coordinate axis dirextAxis is completed, Direct decoding (Bypass coding) continues to be performed on the geometry coordinate of he current point. Assuming that the remaining coding bit depth of each point is nodeSizeLog2 and assuming that the coordinate information of the point is pointPos, the specific decoding process is as follows:

```
for(int axisIdx=0;axisIdx<3;++axisIdx)
for(int idx= nodeSizeLog2[axisIdx]; idx; idx−−){
  pointPos[axisIdx]<<1;
  pointPos[axisIdx]|=decodePosBit( );
}
```

### (II) Laser Radar-Oriented Point Cloud

If the current node includes two points, a priority-coded coordinate axis dirextAxis is obtained first by using the geometry coordinates of the points. Assuming that the geometry coordinate of the current node is nodePos, the determination method is as follows:

$$dirextAxis = ! ( nodePos [ 0 ] < nodePos [ 1 ] )$$

That is, an axis with the smaller node coordinate geometric position is selected as the priority-decoded coordinate axis dirextAxis. It should be noted here that the coordinate axes currently compared only include the x-axis and y-axis, not the z-axis. Secondly, decoding is performed on the geometry information of the priority-decoded coordinate axis dirextAxis first according to the following way. Assuming that a geometry bit depth to be coded corresponding to the priority-decoded coordinate axis is nodeSizeLog2 and assuming that the coordinates of the two points are pointPos[0] and pointPos[1], respectively, the specific decoding process is as follows:

```
Bool sameBit=true;
while(nodeSizeLog2&& sameBit){
  pointPos[0][ dirextAxis]<<1;
  pointPos[1][ dirextAxis]<<1;
    −−nodeSizeLog2;
    int bit=0;
      deEntropyCodeSameBit(sameBits); ///<entropy coding
    if(sameBits){
        bit =decodePosBit( );///<Bypass coding
        pointPos[0][ dirextAxis]|= bit
          pointPos[1][ dirextAxis]|= bit
    }else
        pointPos[1][dirextAxis]|= 1///<The reason here is that when
    encoding, the two points are sorted in the direction of the priority-coded
    axis, so pointPos[0][dirextAxis]<pointPos[1][dirextAxis] can be
    ensured. Therefore, when decoding, if bit information of the two points
    is different, it can be inferred that the bit of the first point is 0 and the bit
    of the second point is 1.
    }
```

After the decoding of the priority-decoded coordinate axis dirextAxis is completed, decoding is performed on the geometry coordinate of the current point.

Similarly, first, a main axis direction of Bypass coding is obtained by using the geometry information of the current node (i.e., nodePos), and then decoding is performed on the geometry information of another dimension by using the geometry information of the direction decoded. Also assuming that an axis direction of Bypass coding is directAxis and assuming that a bit depth to be decoded in Bypass coding is nodeSizeLog2, the decoding method is as follows:

```
for(int idx= nodeSizeLog2[directAxis]; idx; idx−−){
  pointPos[directAxis]<<1;
  pointPos[directAxis]|=decodePosBit( );
}
```

It should be noted here that all geometry accuracy information in the directAxis direction will be decoded.

After the decoding of all accuracy information in directAxis coordinate direction is completed, LaserIdx of the current node (i.e., nodeLaserIdx) is calculated first. Secondly, predictive decoding is performed on LaserIdx of the point (i.e., pointLaserIdx) by using LaserIdx of the node (i.e., nodeLaserIdx), where the calculation manner of LaserIdx of the node or point is the same as that in the encoding side. Finally, decoding is performed on prediction residual information between LaserIdx of the current point and LaserIdx the node to obtain ResLaserIdx. The decoding manner is as follows:

$$PointLaserIdx = nodeLaserIdx + ResLaserIdx$$

After the decoding of LaserIdx of the current point is completed, predictive decoding is performed on the geometry information of the current point in three dimensions using the acquisition parameters of the laser radar. The specific algorithm is as follows.

As illustrated in FIG. 16, first, the prediction value (i.e., φ_{pred}) corresponding to the horizontal azimuth angle is obtained using LaserIdx corresponding to the current point Secondly, the horizontal azimuth angle φ_{node} corresponding to the node is obtained using the node geometry information corresponding to the current point. Assuming that the geometry coordinate of the node is nodePos, the calculation manner between the horizontal azimuth angle φ and the node geometry information is as follows:

$$φ = arctan ( \frac{n o d e P o s [ 1 ]}{n o d e P o s [ 0 ]} )$$

By using the acquisition parameters of the laser radar, the number of rotational points (i.e., numPoints) of each laser may be obtained, and numPoints represents the number of points obtained by each laser ray rotating one full circle. Then, the number of rotational points of each laser may be used to calculate the rotational angular velocity deltaPhi of each laser. The calculation manner is as follows:

$$deltaPhi = \frac{2 π}{n u m P o i n t s}$$

Further, the prediction value of the horizontal azimuth angle φ_{predPoint} corresponding to the current point (that is, the prediction value of the horizontal azimuth angle as illustrated in FIGS. 17A and 17B) is calculated by using the horizontal azimuth angle φ_{node} of the node and the horizontal azimuth angle φ_{pred} of the previous coded point of the laser corresponding to the current point. The calculation manner is as follows:

$${φ}_{predPoint} = \frac{φ pred - φ node}{deltaPhi} \times deltaPhi + φ pred$$

In this way, predictive decoding is performed on the geometry information of the current node by using the prediction value of the horizontal azimuth angle φ_{predPoint} and the horizontal azimuth angle of the low plane φ_{left} of the current node and the horizontal azimuth angle of the high plane φ_{right} of the current node. The details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) ‖ ( angLel < 0 \&\& angLeR < 0 ) ? 0 : 2 ;$$

$$int absAngleL = abs ( angLel ) ;$$

$$int absAngleR = abs ( angLeR ) ;$$

$$context += absAngleL > absAngleR ? 0 : 1 ;$$

$$context += maxAngle > minAngle ≪ 1 ? 4 : 0.$$

After the decoding of LaserIdx of the point is completed, predictive decoding is performed on the Z-axis direction of the current point using LaserIdx corresponding to the current point. That is, depth information (radius) of the radar coordinate system is calculated by using the x and y information of the current point. Then, a tangent value of the current point and an offset in the vertical direction of the current point are obtained by using the laser of the current point(LaserIdx), so that the prediction value of the current point in the Z-axis direction (that is, Z_pred) may be obtained. The details are as follows:

$$int radius = \sqrt{( pointPos [ 0 ] - LidarOrigin [ 0 ] 2 + ( pointPos [ 1 ] - LidarOrigin [ 1 ] ) 2} ;$$

$$int tanTheta = {tan}_{θ laserIdx} ;$$

$$int zOffset = {Z}_{laserIdx} ;$$

$$Z\_pred = tahnTheta - zOffset .$$

Further, the Z_res and Z_pred obtained by decoding are used to reconstruct and restore the geometry information of the current point in the Z-axis direction.

For trisoup (triangle soup)-based geometry information coding, in the trisoup-based geometry information coding framework, geometry partitioning is also performed first. However, unlike the binary tree/quadtree/octree-based geometry information coding, this method does not need to partition the point cloud into unit cubes with side lengths of 1×1×1 level by level, but stops partitioning once there exist sub-blocks (block) with a side length of W. Based on a surface formed by the distribution of the point cloud in each block, at most twelve vertexes are generated where this surface intersects twelve sides of the block. Vertex coordinates of each block are coded in turn to generate a binary bitstream.

For trisoup-based point cloud geometry information reconstruction, when performing point cloud geometry reconstruction, the decoding side first decodes the vertex coordinates to complete trisoup reconstruction, the process of which is illustrated in FIG. 19A, FIG. 19B and FIG. 19C. There are three vertexes (v1, v2, v3) in the block illustrated in FIG. 19A; and a triangle patch set, referred to as triangle soup (i.e., trisoup), is formed by these three vertexes in a certain order, as illustrated in FIG. 19B. Afterwards, sampling is performed on the trisoup to obtain sampling points, which serve as a reconstructed point cloud within the block, as illustrated in FIG. 19C.

For prediction tree-based geometry coding (predictive geometry coding (PredGeomTree)), the PredGeomTree includes steps as follows. First, an input point cloud is sorted, and the sorting methods currently adopted include unordered, Morton order, azimuth order, and radial distance order. The encoding side establishes a prediction tree structure by using two different manners, which include a KD-Tree mode (high-latency slow mode) and a low-latency fast mode (using laser radar calibration information). When the laser radar calibration information is adopted, each point is assigned to different lasers, and a prediction tree structure is established according to different lasers. Next, each node in the prediction tree is traversed based on the prediction tree structure, and prediction is performed on geometry position information of the node by selecting different prediction modes, to obtain a prediction residual; and quantization is performed on the geometry prediction residual by using a quantization parameter. Finally, encoding is performed on the prediction residual of the position information of the node in the prediction tree, the prediction tree structure and the quantization parameter through continuous iteration, to generate a binary bitstream.

For prediction tree-based geometry decoding, the decoding side reconstructs the prediction tree structure by continuously parsing the bitstream; then, obtains the prediction residual information of the geometry position and the quantization parameter of each prediction node through parsing, and performs inverse quantization on the prediction residual, so as to restore and obtain the reconstructed geometry position information of each node; and finally completes the geometry reconstruction at the decoding side.

The geometry information needs to be reconstructed after the geometry encoding is completed. At present, attribute coding is mainly performed on color information. First, the color information is transformed from the RGB color space to the YUV color space. Then, recoloring is performed on the point cloud using the reconstructed geometry information, to enable the unencoded attribute information to correspond to the reconstructed geometry information. In the color information coding, there are two main transform methods: one is the distance-based lifting transform relying on LOD partitioning, and the other is the directly performed RAHT. Both methods can transform the color information from the spatial domain to the frequency domain, and obtain high-frequency coefficients and low-frequency coefficients through transform. Finally, quantization and encoding are performed on the coefficients, to generate a binary attribute bitstream, as illustrated in FIG. 4A and FIG. 4B.

Further, when performing prediction on the attribute information using the geometry information, Morton code may be used to perform nearest neighbor search, where the Morton code corresponding to each point in the point cloud can be obtained according to the geometry coordinates of the point. A specific method for calculating the Morton code is described below. For a three-dimensional coordinate with each component represented by a d-bit binary value, its three components may be represented as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ}$$

Where [symbol] ∈{0,1} are binary values corresponding to bits, from the highest bit ( [symbol] =1) to the lowest bit ( [symbol] =d), of x, y, z, respectively. For x, y, z, starting from the highest bit, [symbol] are crosswise arranged in sequence by using the Morton code M up to the lowest bit. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}}$$

Where [symbol] ∈{0,1} are values of M from the highest bit ( [symbol] =1) to the lowest bit ( [symbol] =3d), respectively. After the Morton code M of each point in the point cloud is obtained, the points in the point cloud are arranged in ascending order of the Morton code, and a weight value w of each point is set to 1.

It may further be understood that for the G-PCC encoding and decoding framework, the general test conditions are as follows.

(1) There are 4 test conditions:
Condition 1: geometry positions with limited loss, and attributes lossy;
Condition 2: geometry positions lossless, but attributes lossy;
Condition 3: geometry positions lossless, and attributes with limited loss; and
Condition 4: geometry positions lossless, and attributes lossless.

(2) The general test sequence includes four categories: Cat1A, Cat1B, Cat3-fused and Cat3-frame. Cat3-frame point cloud only contains reflectance attribute information, Cat1A and Cat1B point clouds only include color attribute information, and Cat3-fused point cloud includes both color and reflectance attribute information.

(3) Technical route: there are two technical routes in total, which are distinguished by the algorithm used for geometry compression.

### Technical Route 1: Octree Coding Branch

At the encoding side, a bounding box is continuously partitioned into sub-cubes, and partitioning is performed on non-empty sub-cubes (including points in the point cloud) sequentially until leaf nodes obtained by partitioning are unit cubes of 1×1×1. In a case of geometry lossless encoding, the number of points included in the leaf node needs to be coded to finally complete the encoding of the geometry octree, to generate a binary bitstream.

At the decoding side, the decoding side obtains, in the order of breadth-first traversal, an occupancy code of each node by continuous parsing, and partitions the nodes in turn until unit cubes of 1×1×1 are obtained by partitioning. In a case of geometry lossless decoding, the number of points included in each leaf node needs to be parsed to finally restore the geometry reconstructed point cloud information.

### Technical Route 2: Prediction Tree Coding Branch

At the encoding side, the prediction tree structure is established by using two different methods, which include: KD-Tree-based mode (a high-latency slow mode) and and a low-latency fast mode (using laser radar calibration information). Each point is assigned to different lasers by adopting the laser radar calibration information, and the prediction tree structure is established according to different lasers. Next, each node in the prediction tree is traversed based on the prediction tree structure, and prediction is performed on the geometry position information of the node by selecting different prediction modes, to obtain the prediction residual; and quantization is performed on the geometry prediction residual by using the quantization parameter. Finally, encoding is performed on the prediction residual of the position information of the nodes in the prediction tree, the prediction tree structure and the quantization parameter through continuous iteration, to generate a binary bitstream.

At the decoding side, the decoding side reconstructs the prediction tree structure by continuously parsing the bitstream; then, obtains the prediction residual information of the geometry position and the quantization parameter of each prediction node through parsing, and performs inverse quantization on the prediction residual, so as to restore and obtain the reconstructed geometry position information of each node; and finally, completes the geometry reconstruction at the decoding side.

It should also be noted that, as illustrated in FIG. 4A or FIG. 4B, at present, G-PCC coding framework includes three attribute coding methods: predicting transform (PT), lifting transform (LT) and region adaptive hierarchical transform (RAHT). The first two methods perform predictive encoding on the point cloud based on the generation order of LODs, and the RAHT performs adaptive transform on attribute information from bottom to top based on the construction hierarchy of the octree. These three point cloud attribute coding methods are introduced below in detail.

### (a) Predictive Coding of Point Cloud Attribute Information

At present, the attribute prediction module of G-PCC adopts a nearest neighbor attribute predictive coding scheme based on a level-of-details (LoDs) structure. The LOD construction methods include a distance-based LOD construction scheme, a fixed sampling rate-based LOD construction scheme, and an octree-based LOD construction scheme. In the distance threshold-based LOD construction scheme, the point cloud is first sorted by Morton code before constructing LOD to ensure that there is a strong attribute correlation between neighboring points. FIG. 20 is a schematic diagram of a distance-based LOD construction process. As illustrated in FIG. 20, the point clouds are partitioned into L different point cloud detail levels (Rl) based on L Manhattan distances (dl) preset by the user, where l=0, 1, . . . L−1, (dl) l=0, 1, . . . L−1 meets dl<dl−1. The construction process of LOD is as follows.

(1) First, all points in the point cloud are marked as unvisited, and a set V is established to store the visited point set. (2) For each iteration l, by traversing the points in the point cloud, if the current point has been visited, the current point is skipped, otherwise, the minimum distance D from the current point to the point set V is calculated; where if D is less than dl, the point is skipped, otherwise, the current point is marked as visited and added to the detail level Rl and the point set V. (3) The points in the level of detail LODl are composed of the points in the detail levels R0, R1, R2 . . . Rl. (4) The above steps are repeated until all points have been marked as visited.

Based on the LOD structure, the attribute value of each point is subjected to linear weighted prediction by using the reconstructed attribute value of the point in the same or higher LOD level, where the maximum number of reference prediction neighbors is determined based on the encoder high-level syntax element. For the attributes of each point, the encoding side adopts the rate-distortion optimization algorithm to select a prediction mode: either performing weighted prediction by using the attributes of the N nearest neighbor points searched or performing prediction by selecting the attributes of a single nearest neighbor point. Finally, encoding is performed on the selected prediction mode and prediction residual.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} )$$

Where N represents the number of prediction points in the nearest neighbor point set of point i, Pᵢ represents a sum of the N nearest neighbor points of point i, Dₘ represents a spatial geometry distance from the nearest neighbor point m to the current point i, Attrₘ represents the attribute value of the nearest neighbor point m after reconstruction,

$${Attr}_{i}^{′}$$

represents the attribute prediction value of the current point i, and the number of points N is a preset numerical value.

In order to balance the attribute coding efficiency and parallel processing between different LOD levels, a switch is introduced in the encoder high-level syntax element to control whether to introduce intra-LOD level prediction. If the switch is turned on, intra-LOD level prediction is initiated, and points in the same LOD level may be used for prediction. It should be noted that in a case where the number of LOD levels is 1, intra-LOD level prediction is always used.

FIG. 21 is a schematic diagram of a visualization result of an LOD generation process. As illustrated in FIG. 21, a subjective example of the distance-based LOD generation process is provided. Specifically (from left to right): the points in the first level represent the outer contour of the point cloud; as the number of detail levels increases, the detailed description of the point cloud becomes clearer.

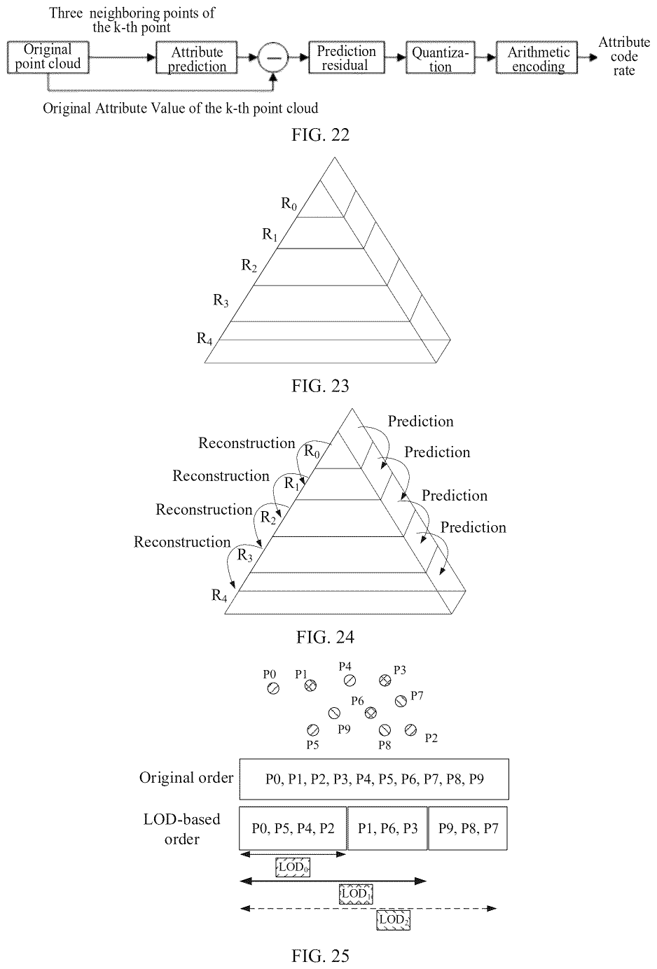

FIG. 22 is a schematic diagram of an encoding process for attribute prediction. As illustrated in FIG. 22, for the specific process of G-PCC attribute prediction, for the original point cloud, three neighbor points of the K-th point are first searched, and then the attribute prediction is performed; the difference between the attribute prediction value of the K-th point and the original attribute value of the K-th point is calculated to obtain a prediction residual of the K-th point; then quantization and arithmetic encoding are performed to finally generate the attribute bitstream.

### (i) Optimal Prediction Value Selection

After the LOD is constructed, three nearest neighbor points of the current point to be coded are first found from the already coded data points according to the generation order of the LOD. The attribute reconstructed values of the three nearest neighbor points are used as candidate prediction values of the current point to be coded. Then, the optimal prediction value is selected from the attribute reconstructed values of the three nearest neighbor points according to rate-distortion optimal (RDO). For example, when coding the attribute value of point P2 in FIG. 20, the prediction variable index of the attribute value of the nearest neighbor point P4 is set to 1; the attribute prediction variable indexes of the second nearest neighbor point P5 and the third nearest neighbor point P0 are set to 2 and 3, respectively; the prediction variable index of the weighted average of points P0, P5 and P4 is set to 0, as shown in Table 1. Finally, the optimal prediction variable is selected using RDO. The formula of weighted average is as follows:

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} )$$

Where \tilde{w}ᵢⱼ represents the spatial geometry weight from the neighbor point j to the current point i:

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}}$$

Where âᵢ represents the attribute prediction value of the current point i, j represents the indexes of the three neighbor points, ãⱼ represents the attribute value of the neighbor point after reconstruction, xᵢ,yᵢ,zᵢ are the geometry position coordinates of the current point, and xᵢⱼ,yᵢⱼ,zᵢⱼ are the geometry coordinates of the neighbor points j.

For example, Table 1 provides an example of candidate prediction samples for attribute coding.

TABLE 1

| Prediction Model | Prediction value |
|---|---|
| 0 | Attribute weighted average of three neighbors |
| 1 | P4 (an attribute value of the first neighbor) |
| 2 | P5 (an attribute value of the second neighbor) |
| 3 | P0 (an attribute value of the third neighbor) |

### (ii) Attribute Prediction Residual and Quantification

Through the above prediction, the attribute prediction value (âᵢ)_{i∈0 . . . k-1} (where k is a total number of points in the point cloud) of the current point i is obtained. Let (aᵢ)_{i∈0 . . . k-1} be the original attribute value of the current point, then the attribute residual (rᵢ)_{i∈0 . . . k-1} is denoted as:

$${r}_{i} = {a}_{i} - \hat{{a}_{i}}$$

Further, the prediction residual is quantified:

$${Q}_{i} = \frac{{r}_{i}}{Q s}$$

Where Qᵢ represents the quantized attribute residual of the current point i, and Qs represents the quantization step (Qs), which may be calculated by the quantization parameter (QP) specified by CTC.

(iii) Reconstructing the Attribute Value at the Encoding Side

The purpose of reconstruction at the encoding side is to predict subsequent points. Before reconstructing the attribute value, inverse quantization needs to be performed on the residual, \hat{r}ᵢ is denoted as the residual after inverse quantization:

$${\hat{r}}_{i} = {Q}_{i} \times Qs$$

The reconstructed value ãᵢ of the point i is obtained by adding \hat{r}ᵢ to the prediction value âᵢ:

$${\tilde{a}}_{i} = {\hat{r}}_{i} + \hat{{a}_{i}}$$

When performing attribute nearest neighbor search based on LOD partitioning, at present, there are two major types of algorithms: intra nearest neighbor search and inter nearest neighbor search. The inter nearest neighbor search algorithm is specifically as follows, and intra nearest neighbor search may be divided into two algorithms: inter-level nearest neighbor search and intra-level nearest neighbor search.

### (I) Intra Nearest Neighbor Search

The intra nearest neighbor search is divided into two algorithms: inter-level nearest neighbor search and intra-level nearest neighbor search. After LOD partitioning, a pyramid-like structure is obtained, as illustrated in FIG. 23.

In a specific implementation, for inter-level nearest neighbor search, the pyramid structure is illustrated in FIG. 24. FIG. 25 is a schematic diagram of an LOD construction process of inter-level nearest neighbor search. As illustrated in FIG. 25, different LOD levels are obtained based on geometry information partitioning, that is, LOD0, LOD1 and LOD2. The points in LOD0 are used to predict the attribute of the point in the next LOD level during the process of the inter-level nearest neighbor search.

The entire process of the intra nearest neighbor search is described in detail below.

In the entire process of LOD partitioning, there are three sets O(k), L(k) and I(k), where k is the index of the LOD level during LOD partitioning, and I(k) is the input point set during the current LOD level partitioning. After LOD partitioning, O(k) set and L(k) set are obtained. The O(k) set stores the sampling point set, and L(k) is the point set of the current LOD level. That is, the entire process of LOD partitioning is as follows.

(1) Initialization,

$$if k = 0 , L ( k ) ← \{ \} ; otherwise L ( k ) ← L ( k - 1 ) ;$$

$$O ( k ) ← \{ \} ;$$

(2) Based on the LOD partitioning algorithm, the sampling points are stored in (k), and the remaining points are partitioned into (k).

(3) In a case of performing the next iteration, I←(k).

It should be noted here that since the entire process of LOD partitioning is performed based on the Morton code, O(k), L(k) and I(k) store the Morton code index corresponding to the point.

When performing inter-level nearest neighbor search, that is, when the points in the L(k) set performing nearest neighbor search in the O(k) set, the search algorithm is as follows.

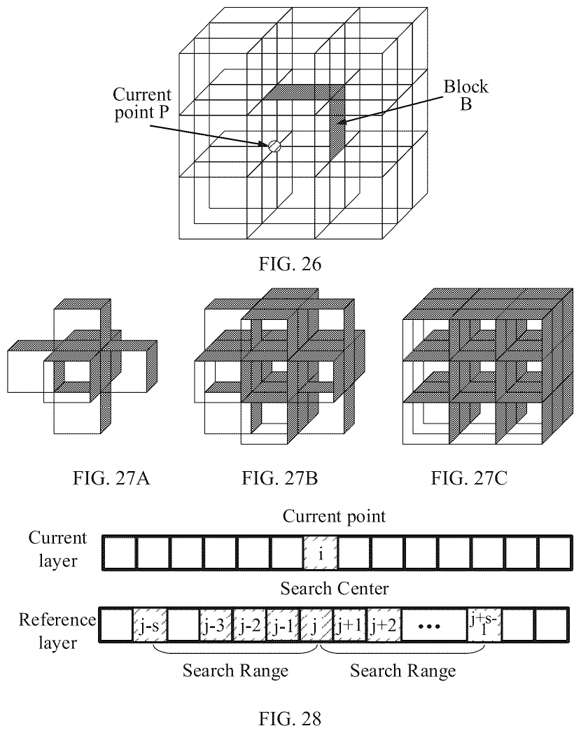

Taking the nearest neighbor search based on the spatial relationship as an example, when predicting the current point P, neighbor search is performed by using the parent block (Block B) corresponding to point P, as illustrated in FIG. 26, to search for points in the neighbor blocks that share a face or edge with the current parent block to perform attribute prediction.

FIG. 27A illustrates a schematic diagram of a co-planar spatial relationship, where there are a total of 6 spatial blocks that have a relationship with the current parent block. FIG. 27B illustrates a schematic diagram of co-planar and co-edge spatial relationships, where there are 18 spatial blocks that have a relationship with the current parent block. FIG. 27C illustrates a schematic diagram of co-planar, co-edge and co-vertex spatial relationships, where there are 26 spatial blocks that have a relationship with the current parent block.

First, a corresponding spatial block is obtained by using the coordinates of the current point. Secondly, the nearest neighbor search is performed in the previously already coded LOD level to search for spatial blocks that share a face, an edge or a vertex with the current block, to obtain the N neighbors of the current point.

If the N neighbors of the current point are still not found after performing co-plana; co-edge and co-vertex nearest neighbor searches, the N neighbors of the current point will be obtained based on a fast search algorithm, and the specific algorithm is as follows.

As illustrated in FIG. 28, when performing attribute inter-level prediction, the Morton code corresponding to the current point is first obtained by using the geometry coordinates of the current point to be coded. Secondly, based on the Morton code of the current point, a reference point (j) whose Morton code is a first one greater than the Morton code of the current point is found in the reference picture. Then, the nearest neighbor search is performed within the range of [j−searchRange, j+searchRange].

Other specific algorithms for updating the nearest neighbor are the same as the inter nearest neighbor search algorithms, which will not be repeated here. The specific algorithms will be mentioned in the inter nearest neighbor search algorithm.

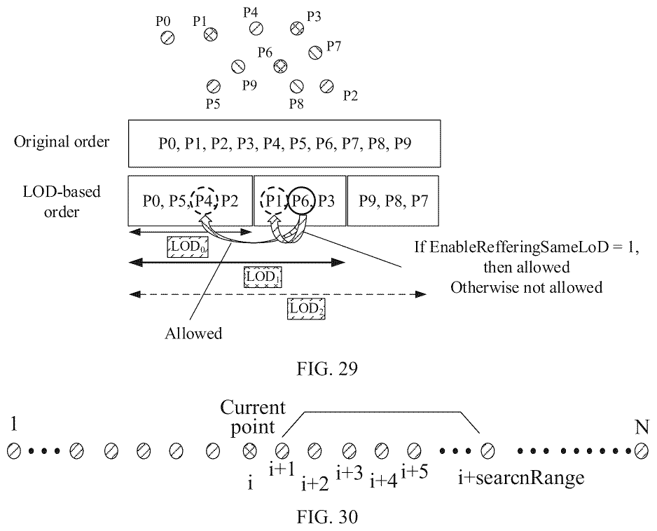

In another specific implementation, for the intra-level nearest neighbor search, FIG. 29 illustrates a schematic diagram of an LOD structure for attribute intra-level nearest neighbor search. As illustrated in FIG. 29, if the intra-level prediction algorithm is turned on, that is, the syntax element EnableRefferingSameLoD=1, then the intra-level nearest neighbor search may be allowed. For example, for the LOD1 level, the nearest neighbor point of the current point P6 may be P1, and the nearest neighbor point is not allowed for other levels; if the syntax element EnableRefferingSameLoD=0, then inter-level search is allowed for other levels. For example, for the LOD1 level, the nearest neighbor point of the current point P6 may be P4. That is, when the intra-level prediction algorithm is turned on, in the same LOD level, the nearest neighbor search is performed on the set of already coded points of the same level, to obtain the N neighbors of the current point (inter-level nearest neighbor search is also performed).

When performing attribute intra-level prediction, the nearest neighbor search is performed based on the fast search algorithm. The specific algorithm is illustrated in FIG. 30. The current point is represented by grids. Assuming that the Morton code index of the current point is i, the nearest neighbor search is performed within [i+1, i+searchRange]. The specific nearest neighbor search algorithm is consistent with the block-based inter fast search algorithm, which will not be repeated here.

### (II) Inter Nearest Neighbor Search

FIG. 28 is a schematic diagram of attribute inter prediction. As illustrated in FIG. 28, when performing attribute inter prediction, the Morton code corresponding to the current point is first obtained by using the geometry coordinates of the current point to be coded. Secondly, based on the Morton code of the current point, a reference point (j) whose Morton code is the first one greater than the Morton code of the current point is found in the reference picture. Then, the nearest neighbor search is performed within the range of [j−searchRange, j+searchRange].

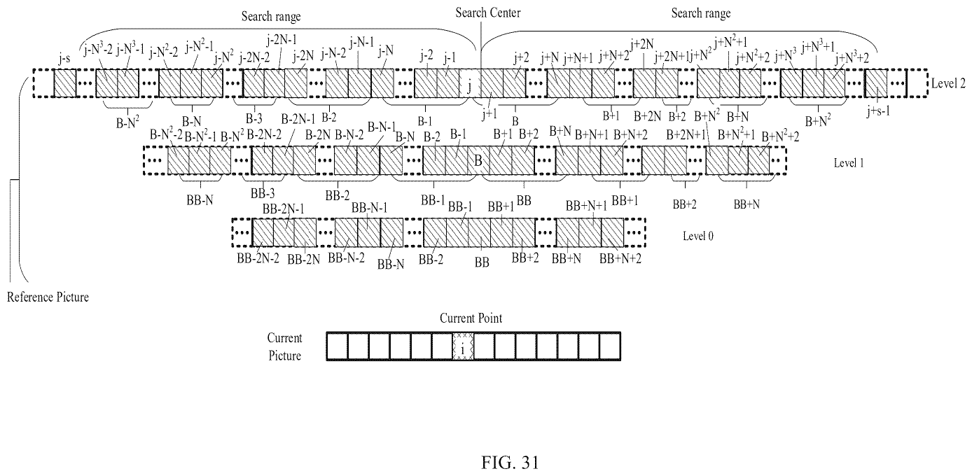

At present, when performing intra nearest neighbor search and inter nearest neighbor search, the neighborhood search is performed based on blocks, and the details are illustrated in FIG. 31. As illustrated in FIG. 31, when performing neighborhood searching on the current point (Morton code index is i), the points in the reference picture are first partitioned into N (N is equal to 3) levels according to the Morton code. The specific partitioning algorithm is as follows.

First level: it is assumed that the number of points in the reference picture is numPoints, the points in the reference picture are first partitioned into a block every M (M=2⁵=32) points.

Second level: on the basis of the first level, the blocks of the first level are partitioned into one block every M (M=2⁵=32) blocks according to the order of Morton code.

Third level: on the basis of the second level, the blocks of the second level are partitioned into one block every M (M=2⁵=32) blocks according to the order of Morton code.

Finally, the prediction structure illustrated in FIG. 31 is obtained.

When performing attribute prediction based on the prediction structure illustrated in FIG. 31, assuming that the Morton code index of the current point to be coded is i, a point in the reference picture whose Morton code is the first one greater than or equal to the Morton code of the current point is first obtained, in which an index of the point is j. Secondly, the block index of the reference point is calculated based on j. The specific calculation method is as follows.

$$First level : BucketSize\_ 0 = {2}^{5} = 32.$$

$$Second level : BucketSize\_ 1 = {2}^{5} = 32 \times BucketSize\_ 0 = 1024.$$

$$Third level : BucketSize\_ 2 = {2}^{5} = 32 \times BucketSize\_ 1 = 32768 .$$

Assuming that the reference range in the prediction picture of the current point is [j−searchRange, j+searchRange], a starting index of the third level is calculated using j−searchRange, and an ending index of the third level is calculated using j+searchRange. Next, in the blocks of the third level, it is determined whether nearest neighbor search needs to be performed on some blocks in the second level; then, in the second level, it is determined whether search needs to be performed on each block of the first level; if nearest neighbor search needs to be performed on some blocks in the first level, points of some blocks in the first level are determined point by point to update the nearest neighbors.

An index-based algorithm for block calculation is introduced below. Assuming that the Morton code index corresponding to the current point is “index”, an index corresponding to the block in the third level is:

$$idx\_ 2 = index / BucketSize\_ 2$$

After the block index idx_2 in the third level is obtained, a starting index and an ending index of the block in the second level corresponding to the current block may be obtained using idx_2:

$$startIdx 1 = idx\_ 2 \times BucketSize\_ 1$$

$$endIdx = idx\_ 2 \times BucketSize\_ 1 + BucketSize\_ 1 - 1$$

Based on the same algorithm, an index of the block in the first level is obtained based on an index of the block in the second level.

When performing nearest neighbor search based on blocks, it is first determined whether nearest neighbor search needs to be performed on the current block, that is, nearest neighbor search of the block is filtered. Each spatial block may be obtained based on two variables minPos and maxPos, where minPos represents the minimum value of the block, and maxPos represents the maximum value of the block.

It is assumed that a distance of the farthest point among the searched N neighbors of the current point is Dist, the coordinates of the point to be coded are (x, y, z), and the current block is represented by (minPos, maxPos), where minPos is the minimum value of the bounding box in three dimensions, and maxPos is the maximum value of the bounding box in three dimensions, then a distance D between the current point and the bounding box is calculated as follows:

$$int dx = int ( std \text{::} max ( std \text{::} max ( minPos [ 0 ] - point [ 0 ] , 0 ) , point [ 0 ] - maxPos [ 0 ] ) ) ;$$

$$int dy = int ( std \text{::} max ( std \text{::} max ( minP os [ 1 ] - point [ 1 ] , 0 ) , point [ 1 ] - maxPos [ 1 ] ) ) ;$$

$$int dz = int ( std \text{::} max ( std \text{::} max ( minPos [ 2 ] - point [ 2 ] , 0 ) , point [ 2 ] - maxPos [ 2 ] ) ) ;$$

$$D = dx + dy + dz ;$$

Only when D is less than or equal to Dist, will the points in the current block be traversed.

### (b) Lifting Transform Coding of Attribute Information of a Point Cloud.

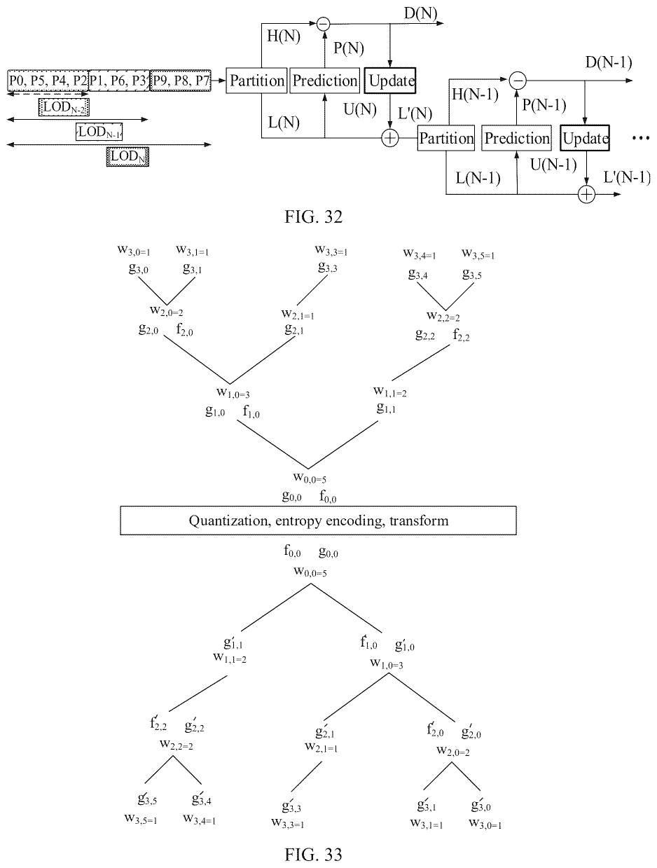

FIG. 32 is a schematic diagram of a coding process of lifting transform. The lifting transform is also used to perform predictive coding on the attributes of the point cloud based on LOD. The difference from the prediction transform is that the lifting transform is first used to partition the LOD into higher and lower levels, perform prediction in reverse order of LOD generation levels, and introduce an update operator in the prediction process to update quantization weights of points in the lower LOD level to improve the accuracy of the prediction. The reason is that attribute values of the points in the lower LOD level are frequently used to predict attribute values of points in the higher LOD level, so the points in the lower LOD level should have greater influence.

### Step 1: Partitioning Process

The partitioning process is to partition a complete LOD level into lower LOD levels L(N) and higher LOD levels H(N). If a certain point cloud has three LOD levels, i.e., (LODₗ)_{l=0,1,2}, after partitioning, LOD₂ is the higher LOD level and denoted as H(N), and (LODₗ)_{l=0,1} are the lower LOD levels and denoted as L(N).

### Step 2: Prediction Process

A point in the higher LOD level selects attribute information of the nearest neighbor point from the lower level as the attribute prediction value P(N) of the current point to be coded. The prediction residual D(N) is denoted as:

$$D ( N ) = H ( N ) - P ( N )$$

### Step 3: Update Process

The attribute prediction residual D(N) in the higher LOD level is updated to obtain U(N), and attribute values of the points in the lower LOD level are lifted using U(N), as shown in the following formula:

$${L}^{′} ( N ) = L ( N ) + U ( N )$$

The above process will iterate continuously until the lowest LOD level according to the order of LOD from high to low.

Since the LOD-based prediction scheme makes the points in the lower LOD levels have greater influence, the lifting wavelet transform-based transform scheme introduces the quantization weights and updates the prediction residuals according to the prediction residual D(N) and the distance between the prediction point and the neighboring points. Finally, adaptive quantization is performed on the prediction residual by using the quantization weight in the transform process. It should be noted here that the quantization weight value of each point may be determined by geometry reconstruction at the decoding side, so the quantization weight does not need to be coded.

### (c) Region Adaptive Hierarchical Transform

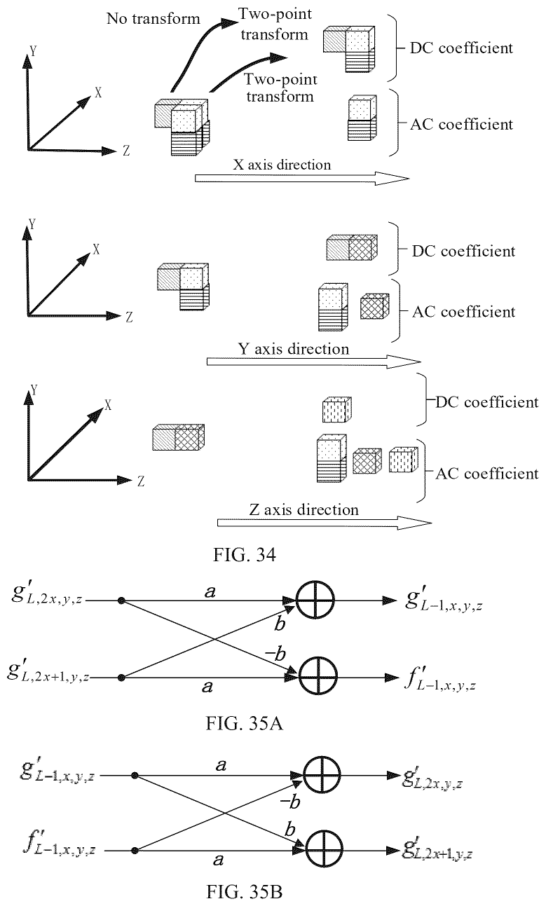

The region adaptive hierarchical transform (RAHT) is a Haar wavelet transform that may transform the attribute information of the point cloud from the spatial domain to the frequency domain and further reduce the correlation between the attributes of the point cloud. The main idea of the RAHT is to transform the nodes in each level along the three dimensions of X, Y, and Z in a bottom-up manner according to the octree structure (as illustrated in FIG. 34), and to perform iteration until reaching the root node of the octree. As illustrated in FIG. 33, the basic idea is to perform wavelet transform based on the hierarchical structure of the octree, to associate the attribute information with the nodes of the octree, and to recursively transform the attributes of the occupied nodes in the same parent node in a bottom-up manner. The nodes in each level are transformed along the three dimensions of X, Y, and Z until reaching the root node of the octree. In the process of hierarchical transform, the low-pass/low-frequency (DC) coefficients obtained after transforming the nodes in the same level are passed to the nodes in the next level to be further transformed, while all the high-pass/high-frequency (AC) coefficients may be encoded by the arithmetic encoder.

During the transformation process, the DC coefficients (direct current components) of the nodes in the same level after transformation will be passed to the previous level to be further transformed, while the AC coefficients (alternating current components) after transformation of each level will be quantized and encoded. The main transform process is introduced below.

FIG. 35A is a schematic diagram of a RAHT forward transform process, and FIG. 35B is a schematic diagram of a RAHT inverse transform process. For the transform and inverse transform process corresponding to RAHT, it is assumed that

$${g}_{L , 2 x , y , z}^{′} and {g}_{L , 2 x + 1 , y , z}^{′}$$

are two attribute DC coefficients of points that are neighboring points in the L level. After linear transform, the information of the L−1 level is AC coefficient

$${g}_{L - 1 , x , y , z}^{′}$$

and DC coefficient

$${g}_{L - 1 , x , y , z}^{′} .$$

Then, no transform is performed on

$${f}_{L - 1 , x , y , z}^{′}$$

and quantization and encoding are performed on

$${f}_{L - 1 , x , y , z}^{′}$$

directly;

$${g}_{L - 1 , x , y , z}^{′}$$

will continue to search neighbors to transform, and it will be passed directly to the L−2 level if no neighbor is found. That is, the RAHT transform is only valid for nodes that have neighboring points, and nodes that do not have neighboring points will be passed directly to the previous level. In the above transform process, the weights (the number of non-empty child nodes in the node) corresponding to

$${g}_{L , 2 x , y , z}^{′} and {g}_{L , 2 x + 1 , y , z}^{′} are {w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 , x , y , z}^{′} is {w}_{L - 1 , x , y , z}^{′} ,$$

then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

Where T_{w0,w1} is a transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ]$$

The transform matrix is adaptively changed and updated as the weights corresponding to each point. The above process is continuously iterated and updated according to the partition structure of octree until reaching the root node of the octree.

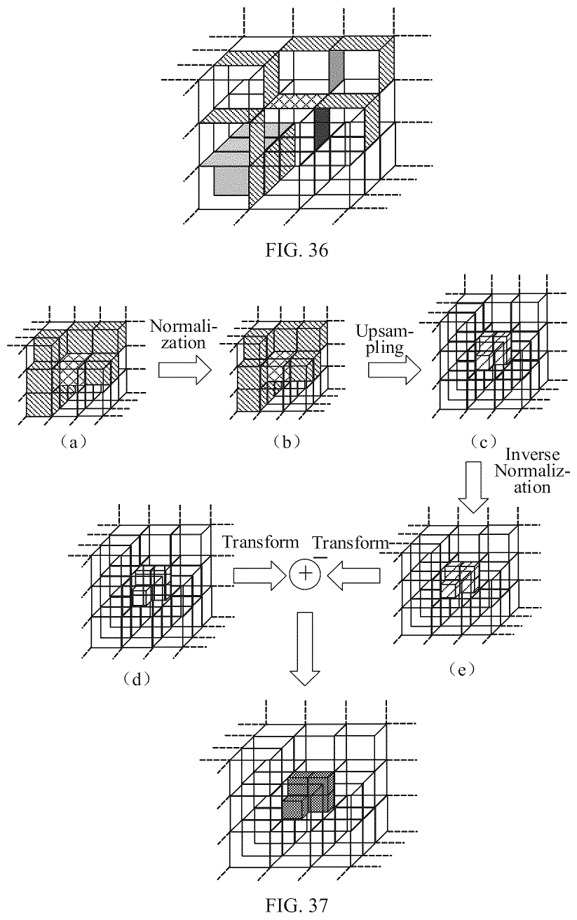

In a specific implementation, for region adaptive hierarchical intra prediction transform coding, prediction may be performed based on RAHT transform coding. As illustrated in FIG. 33, based on the level order of the octree, the RAHT attribute transform is performed continuously at the voxel level until reaching the root node, so as to complete the entire attribute hierarchical transform coding. In prediction transform coding, attribute prediction transform coding is also performed based on the level order of the octree, but the transform is performed continuously from the root node to the voxel level. In each RAHT attribute transform process, attribute prediction transform coding is performed based on blocks of 2×2×2. The details are illustrated in FIG. 36. As illustrated in FIG. 36, it may be seen that the block filled with grids is the current block to be coded, and the blocks filled with diagonal lines are some neighborhood blocks that share a face or an edge with the current block to be coded. The attributes of the current block are normalized in the following way:

$${A}_{node} = {\sum }_{p ∈ node} attribute ( p ) ;$$

$${w}_{node} = {\sum }_{p ϵ node} 1 = \{ p ∈ node \} ;$$

$${a}_{node} = {A}_{node} / {w}_{node} .$$

First, the attributes of the current block (i.e., A_{node}) may be obtained by using the attributes of the points included in the current block. The mean value of the attributes of the current block a_{node} is obtained by simply adding the attributes of the points included in the current block and then normalizing the attributes of the current block with the number of points in the current block. Attribute transform coding is performed by using the mean value of the attributes of the current block, and the specific encoding process is illustrated in FIG. 37.

The entire process of RAHT attribute prediction transform coding is illustrated in FIG. 37. Here, (a) is the current block and some neighborhood blocks that share a face and an edge with the current block, (b) is the block after normalization, (c) is the block after upsampling, (d) is the attributes of the current block, and (e) is the attributes of the prediction block obtained by linear weighted approximation using the neighborhood attributes of the current block. Finally, the attribute transform is performed on the two (i.e., the attributes of the current block and the attributes of the prediction block), respectively, to obtain the DC coefficients and the AC coefficients, and predictive coding is performed on the AC coefficients.

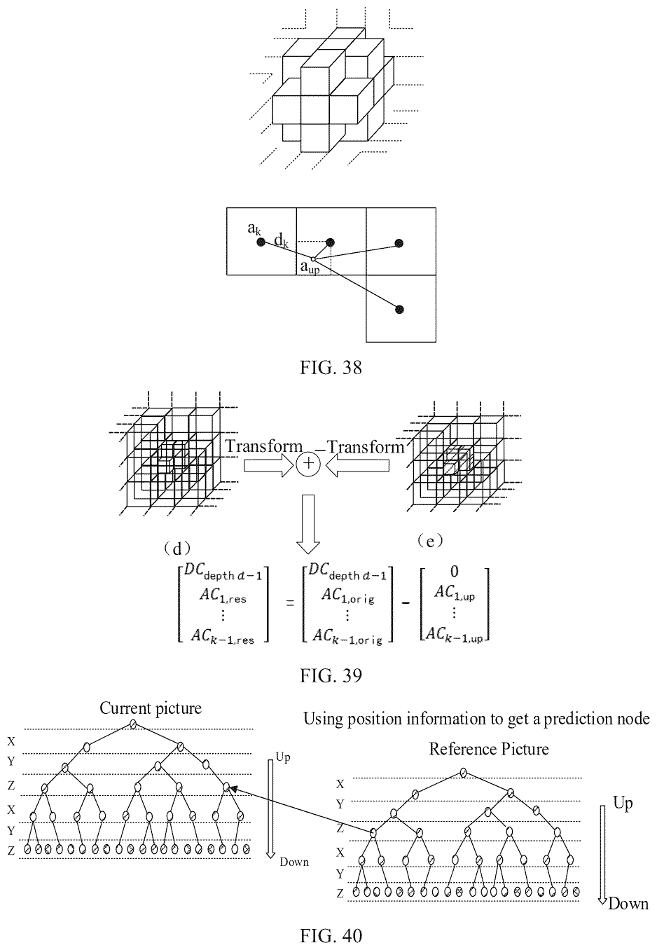

The prediction attributes of the current block may be obtained by performing linear approximation as illustrated in FIG. 38. As illustrated in FIG. 38, 19 neighborhood blocks of the current block are first obtained; then, the linear weighted prediction is performed on the attributes of each sub-block by using the spatial geometry distance between the neighborhood blocks and each sub-block of the current block; and finally, transform is performed by using the prediction block attributes obtained by linear weighting. The specific attribute transform is illustrated in FIG. 39.

In FIG. 39, (d) represents the attribute original values, and the corresponding attribute transform coefficients are as follows:

$$[ \begin{matrix}* \\ {AC}_{1 , orig} \\ ⋮ \\ {AC}_{k - 1 , orig}\end{matrix} ] = {T}_{node} [ \begin{matrix}{A}_{1} , \frac{orig}{\sqrt{{w}_{1}}} \\ ⋮ \\ \frac{{A}_{k , orig}}{\sqrt{{w}_{k}}}\end{matrix} ]$$

(e) represents the attribute prediction values, and the corresponding attribute transform coefficients are as follows:

$$[ \begin{matrix}* \\ {AC}_{1 , up} \\ ⋮ \\ {AC}_{k - 1 , up}\end{matrix} ] = {T}_{node} [ \begin{matrix}\frac{{A}_{1 , up}}{\sqrt{{w}_{1}}} \\ ⋮ \\ \frac{{A}_{k , up}}{\sqrt{{w}_{k}}}\end{matrix} ]$$

The prediction residuals are obtained by subtracting the attribute prediction values from the attribute original values as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ]$$

In another specific implementation 1, for region adaptive hierarchical inter prediction transform coding, in G-PCC attribute inter prediction, a process that is similar to intra prediction coding process is performed. First, the RAHT attribute transform coding structure is constructed based on the geometry information, that is, the transform is continuously performed from the voxel level until reaching the root node, so as to complete the entire attribute hierarchical transform coding. In this way, the intra coding structure and inter attribute coding structure are constructed as illustrated in FIG. 40.

As illustrated in FIG. 40, first, a collocated prediction node of a node to be coded is obtained in the reference picture by using the geometry information of the current node to be coded, and then the prediction attribute of the current node to be coded is obtained by using the geometry information and attribute information of a reference node.

The attribute prediction value of the current node to be coded is obtained according to the following two different manners.

(1) The inter prediction node of the current node is valid, that is, the collocated node is present, the attribute of the prediction node is directly used as the attribute prediction value of the current node to be coded.

(2) The inter prediction node of the current node is invalid, that is, the collocated node is not present, then the attribute prediction value of the intra neighboring node is used as the attribute prediction value of the node to be coded.

Finally, prediction is performed on the attribute of the current node to be coded by using the obtained attribute prediction value, so as to complete the entire attribute predictive coding.

In another specific implementation 2, for region adaptive hierarchical inter prediction transform coding, in the G-PCC attribute inter prediction coding scheme, the difference from the above-mentioned inter prediction coding scheme is that: if the inter prediction coding scheme is enabled, the RAHT attribute transform coding structure is first constructed based on the geometry information of the current node to be coded, that is, the nodes are continuously merged at the voxel level until reaching the root node of the entire RAHT transform tree, so as to complete the entire attribute transform coding hierarchical structure. Secondly, according to the RAHT attribute transform coding structure, the root node is partitioned to obtain N child nodes of each node (N is less than or equal to 8). First, orthogonal transform is performed on the attributes of the N child nodes by using RAHT transform, independently, to obtain the DC coefficients and the AC coefficients. Then, attribute inter prediction is performed on the AC coefficients of the N child nodes according to the following way.

If the inter prediction node of the current node is valid, that is, the collocated node is present, the attribute of the prediction node is directly used as the attribute prediction value of the current node to be coded, where the current node to be coded may also be understood as the current node.

A node with exactly the same position as the current node in the buffer of the reference picture may be searched for the current node, that is, the collocated node is present, the AC coefficients of the M child nodes included in the collocated node are directly used as the AC coefficient attribute prediction values of the N child nodes of the current node.
If the AC coefficient of the prediction node is not zero, the AC coefficient of the prediction node is directly used as the AC coefficient prediction value.
If the AC coefficient of the prediction node is zero, the AC coefficient of the corresponding child node of the intra prediction is used as the AC coefficient prediction value.

If the inter prediction node of the current node is invalid, that is, the collocated node is not present, then the attribute prediction value of the intra neighboring node is used as the attribute prediction value of the node to be coded.

In the above G-PCC attribute RAHT inter prediction coding, it is determined whether to enable RAHT attribute inter prediction coding by using the high-level aps syntax element. When the RAHT inter prediction coding is enabled, itis determined whether to adopt the above implementation 1 or the above implementation 2. However, in the related RAHT attribute inter prediction coding, only unidirectional attribute inter prediction coding is adopted, that is, the current node to be coded has only one reference node. Based on such coding scheme, there are the following major problems: 1) only temporal redundancy between the forward reference picture and the current picture to be coded is considered, but the temporal redundancy between the backward reference picture and the current picture to be coded is not considered; 2) since in the related RAHT attribute inter coding scheme, regardless of whether it is the above implementation 1 or the above implementation 2, when determining whether to enable inter prediction coding for the current node, it is also necessary to consider whether each node has a collocated node in the reference picture in a case where the inter prediction coding is enabled for the current coding unit; and if the collocated node is present, the inter prediction coding scheme is enabled for the current node, otherwise, only intra prediction coding is adopted. Based on such coding scheme, only unidirectional or single-frame prediction list-based inter prediction coding is adopted, first, the temporal redundancy characteristics between neighboring pictures are not fully utilized, and the temporal correlation between neighboring pictures cannot be removed. Secondly, since the point cloud is sparsely distributed data, in related coding schemes, the inter prediction coding scheme cannot be enabled for some nodes because there is no collocated node in the unidirectional reference picture can be searched for these nodes, and the efficiency of the inter attribute coding is further reduced.

Based on the above analysis, in the embodiments of the present application, a RAHT attribute transform-based bidirectional reference inter prediction coding scheme is provided. In this scheme, first, a reference of a bidirectional prediction list is introduced in the RAHT attribute inter prediction coding; and secondly, attribute inter prediction coding is performed on the attribute AC coefficient of the current node to be coded based on the reconstructed attributes/reconstructed AC coefficients of the bidirectional reference list. Compared with the above-mentioned prediction coding scheme, in such coding scheme, the slot (temporal) redundancy characteristics between the current picture to be coded and the forward reference picture and the backward reference picture are considered. In addition, for the node to be coded, since the nodes available for reference are changed from the original unidirectional prediction nodes to bidirectional prediction nodes, for each node to be coded, the number of reference objects that may be selected for inter prediction is more than that of the original coding scheme, thereby more effectively removing the slot (temporal) redundancy characteristics between neighboring coding pictures.

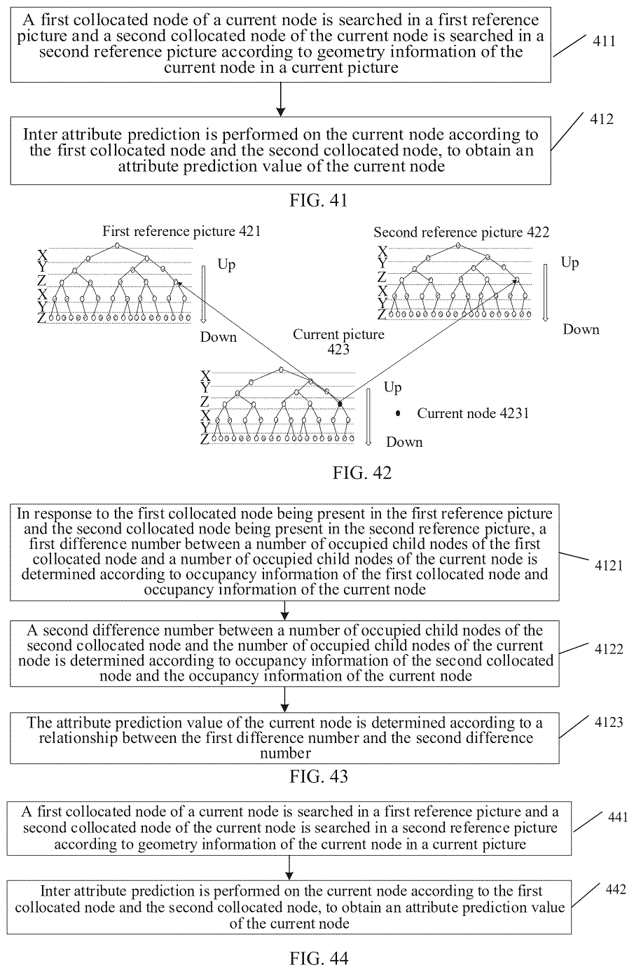

The embodiments of the present application provide an encoding method, which is applied to an encoder. FIG. 41 is a schematic flowchart of an implementation of the encoding method provided by the embodiments of the present application. As illustrated in FIG. 41, the encoding method includes the following steps 411 to 412.

In step 411: a first collocated node of a current node is searched in a first reference picture and a second collocated node of the current node is searched in a second reference picture according to geometry information of the current node in a current picture.

In step 412: inter attribute prediction is performed on the current node according to the first collocated node and the second collocated node, to obtain an attribute prediction value of the current node.

In the embodiments of the present application, for the encoding method of the point cloud, when determining the attribute prediction value of the current node, it is based not only on the collocated node of the current node in the first reference picture, but also on the collocated node of the current node in the second reference picture. In this way, it is beneficial for improving the accuracy of inter attribute prediction, so that the temporal redundancy between pictures can be further compressed and the point cloud bitstream can be saved.

The optional implementations of each of the above steps and related terms are further described below.

In step 411, the first collocated node of the current node is searched in the first reference picture and the second collocated node of the current node is searched in the second reference picture according to the geometry information of the current node in the current picture.

It is to be understood that the first collocated node and the second collocated node refer to nodes having the same geometry information/geometry coordinates as the current node. In the embodiments of the present application, the current picture, the first reference picture and the second reference picture may be understood as different point cloud frames. In some embodiments, the arrangement structure of the point cloud of the current picture, the first reference picture and the second reference picture is a RAHT attribute transform coding structure. The encoder may construct the RAHT attribute transform coding structure based on the geometry information of nodes, that is, the nodes are continuously merged starting from the voxel level until the root node of the entire RAHT transform tree is obtained. For example, as illustrated in FIG. 42, the first reference picture is 421, the second reference picture is 422, and the current picture is 423. It is assumed that the current node is 4231, and its first collocated node and its second collocated node are the nodes indicated by the arrows in FIG. 42.

In the embodiments of the present application, there is no limitation on the relationship between the first reference picture and the current picture and the relationship between the second reference picture and the current picture. The first reference picture and the second reference picture may be two pictures forward of the current picture; or two pictures backward of the current picture; or the first reference picture may be the forward reference picture of the current picture, and the second reference picture may be the backward reference picture of the current picture.

In step 412, inter attribute prediction is performed on the current node according to the first collocated node and the second collocated node, to obtain the attribute prediction value of the current node.

Optionally, in some embodiments (for the convenience of description, this embodiment is referred to as Embodiment I), the step 412 includes: in response to the first collocated node being present in the first reference picture and the second collocated node being present in the second reference picture, determining the attribute prediction value of the current node according to an attribute reconstructed value of the first collocated node and an attribute reconstructed value of the second collocated node.

In some other embodiments (for ease of description, this embodiment is referred to as Embodiment II), as illustrated in FIG. 43, the step 412 includes the following steps 4121 to 4123.

In step 4121: in response to the first collocated node being present in the first reference picture and the second collocated node being present in the second reference picture, a first difference number between a number of occupied child nodes of the first collocated node and a number of occupied child nodes of the current node is determined according to occupancy information of the first collocated node and occupancy information of the current node.

In step 4122: a second difference number between a number of occupied child nodes of the second collocated node and the number of occupied child nodes of the current node is determined according to occupancy information of the second collocated node and the occupancy information of the current node.

In step 4123: the attribute prediction value of the current node is determined according to a relationship between the first difference number and the second difference number.

Further, in some embodiments, the step 4123 includes the following:
(1) in response to the first difference number being equal to the second difference number, determining the attribute prediction value of the current node according to an attribute reconstructed value of the first collocated node and an attribute reconstructed value of the second collocated node; or
(2) in response to the first difference number being smaller than the second difference number, determining the attribute prediction value of the current node according to an attribute reconstructed value of the first collocated node; or
(3) in response to the first difference number being greater than the second difference number, determining the attribute prediction value of the current node according to an attribute reconstructed value of the second collocated node.

For example, in some embodiments, in a case where the first difference number is smaller than the second difference number, the attribute prediction value of the current node is equal to the attribute reconstructed value of the first collocated node; and in a case where the first difference number is greater than the second difference number, the attribute prediction value of the current node is equal to the attribute reconstructed value of the second collocated node.

It is to be understood that the occupancy information of the first collocated node, the second collocated node and the current node all records occupancy status of their respective child nodes. The smaller the difference number between the number of the occupied child nodes of the current node and the number of the occupied child nodes of the collocated node, the stronger the geometry correlation between the corresponding two frames of the point clouds/two pictures. Correspondingly, the stronger the attribute correlation between the two frames of the point clouds/two pictures, the greater the temporal redundancy between the two frames of the point clouds/two pictures. Therefore, when the first difference number between the number of the occupied child nodes of the first collocated node and the number of the occupied child nodes of the current node is less than the second difference number between the number of the occupied child nodes of the second collocated node and the number of the occupied child nodes of the current node, it indicates that there is greater temporal redundancy between the current picture and the first reference picture than between the current picture and the second reference picture. Therefore, in this case, the attribute prediction value of the current node may be determined based on the attribute reconstructed value of the first collocated node, for example, the attribute reconstructed value of the first collocated node is directly used as the attribute prediction value of the current node. In this way, compared with the operation of determining the attribute prediction value of the current node based on the attribute reconstructed value of the second collocated node in this case, the temporal redundancy may be better compressed, thereby improving the encoding and decoding performance of the point cloud. Similarly, when the first difference number is greater than the second difference number, the attribute prediction value of the current node is determined based on the attribute reconstructed value of the second collocated node. In this way, compared with the operation of determining the attribute prediction value of the current node based on the attribute reconstructed value of the first collocated node, the temporal redundancy may be better compressed, thereby improving the encoding and decoding performance of the point cloud.

Regarding the operation of “determining the attribute prediction value of the current node according to an attribute reconstructed value of the first collocated node and an attribute reconstructed value of the second collocated node” mentioned in both the Embodiments I and II, in some embodiments, it may be implemented as follows: performing a weighting operation on the attribute reconstructed value of the first collocated node and the attribute reconstructed value of the second collocated node according to a first weighting coefficient of the attribute reconstructed value of the first collocated node and a second weighting coefficient of the attribute reconstructed value of the second collocated node, to obtain the attribute prediction value of the current node.

For example, in some embodiments, the first weighting coefficient is equal to a first numerical value, and the second weighting coefficient is equal to a second numerical value. That is, the first weighting coefficient and the second weighting coefficient are predefined numerical values, which may be equal or unequal, but the sum of which is equal to 1.

In other embodiments, the first weighting coefficient may be determined according to an interval between an acquisition time of the current picture and an acquisition time of the first reference picture; and/or the second weighting coefficient may be determined according to an interval between an acquisition time of the current picture and an acquisition time of the second reference picture. For example, the longer the interval, the larger the value of the weighting coefficient. Itis assumed that the interval between the acquisition time of the current picture and the acquisition time of the first reference picture is greater than the interval between the acquisition time of the current picture and the acquisition time of the second reference picture, the first weighting coefficient is smaller than the second weighting coefficient.

Specifically, in some embodiments, a mapping table between the interval of the acquisition time and the weighting coefficient may be predefined, so that the encoder may determine the first weighting coefficient and the second weighting coefficient by looking up the table. Certainly, the present application is not limited to the method of determining the weighting coefficient based on the table lookup method, and in summary, the corresponding weighting coefficient may be determined according to the interval between the acquisition times of two pictures.

In some other embodiments, the encoder may further determine the first weighting coefficient and the second weighting coefficient as follows: determining a respective rate-distortion cost for each of multiple candidate weighting coefficient groups, where the candidate weighting coefficient group includes a first candidate weighting coefficient of the attribute reconstructed value of the first collocated node and a second candidate weighting coefficient of the attribute reconstructed value of the second collocated node; selecting a candidate weighting coefficient group with a smallest rate-distortion cost from the multiple candidate weighting coefficient groups; taking a first candidate weighting coefficient in the candidate weighting coefficient group with the smallest rate-distortion cost as the first weighting coefficient, and taking a second candidate weighting coefficient in the candidate weighting coefficient group with the smallest rate-distortion cost as the second weighting coefficient.

It may be understood that, at the encoding side, since an actual attribute value of the current node is known, the rate-distortion cost of the candidate weighting coefficient group may be determined. Correspondingly, the method further includes the following. The encoder signals the first weighting coefficient and the second weighting coefficient obtained based on the rate-distortion cost into a bitstream, and the decoder obtains the first weighting coefficient and the second weighting coefficient by parsing the bitstream.

The method for determining the attribute prediction value of the current node when both the first collocated node and the second collocated node are present. It may be understood that the first collocated node may be not present in the first reference picture, and/or the second collocated node may be not present in the second reference picture. In this case, how to perform inter attribute prediction on the current node according to the first collocated node and the second collocated node to obtain the attribute prediction value of the current node refers to the embodiments described below.

In some embodiments, the operation that inter attribute prediction is performed on the current node according to the first collocated node and the second collocated node, to obtain the attribute prediction value of the current node in step 412 further includes the following.

(1) In response to the first collocated node being not present in the first reference picture and the second collocated node being present in the second reference picture, the attribute prediction value of the current node is determined according to an attribute reconstructed value of the second collocated node.

(2) In response to the first collocated node being present in the first reference picture and the second collocated node being not present in the second reference picture, the attribute prediction value of the current node is determined according to an attribute reconstructed value of the first collocated node.

(3) In response to the first collocated node being not present in the first reference picture and the second collocated node being not present in the second reference picture, the attribute prediction value of the current node is determined according to an attribute reconstructed value of at least one neighborhood node of the current node in the current picture. For example, the attribute prediction value of the current node is determined according to the attribute reconstructed value of the at least one neighborhood node.

For example, in some embodiments, in a case where the first collocated node is not present in the first reference picture and the second collocated node is present in the second reference picture, the attribute prediction value of the current node is equal to the attribute reconstructed value of the second collocated node.

For example, in some embodiments, in a case where the first collocated node is present in the first reference picture and the second collocated node is not present in the second reference picture, the attribute prediction value of the current node is equal to the attribute reconstructed value of the first collocated node.

In some embodiments, the encoding method further includes: determining an attribute residual value of the current node according to the attribute prediction value of the current node; and generating a bitstream according to the attribute residual value of the current node.

For example, in some embodiments, the attribute prediction value of the current node is a prediction value of an AC coefficient of the current node, and the attribute residual value of the current node is a residual value of the AC coefficient of the current node. The encoder may determine the residual value of the AC coefficient of the current node according to the prediction value of the AC coefficient of the current node and an actual value of the AC coefficient of the current node.

The embodiments of the present application provide a decoding method. FIG. 44 is a schematic flowchart of an implementation of the decoding method provided by the embodiments of the present application. As illustrated in FIG. 44, the decoding method includes the following steps 441 to 442.

In step 441: a first collocated node of a current node is searched in a first reference picture and a second collocated node of the current node is searched in a second reference picture according to geometry information of the current node in a current picture.

In step 442: inter attribute prediction is performed on the current node according to the first collocated node and the second collocated node, to obtain an attribute prediction value of the current node.

In the embodiments of the present application, for the decoding method of the point cloud, the inter attribute prediction method similar to that of the encoding side is adopted, that is, when determining the attribute prediction value of the current node, it is based not only on the collocated node of the current node in the first reference picture, but also on the collocated node of the current node in the second reference picture. In this way, it is beneficial for improving the accuracy of inter attribute prediction, and thus is beneficial for restoring higher quality point cloud data.

In some embodiments, the operation that inter attribute prediction is performed on the current node according to the first collocated node and the second collocated node to obtain the attribute prediction value of the current node includes: in response to the first collocated node being present in the first reference picture and the second collocated node being present in the second reference picture, determining the attribute prediction value of the current node according to an attribute reconstructed value of the first collocated node and an attribute reconstructed value of the second collocated node.

In some embodiments, the operation that inter attribute prediction is performed on the current node according to the first collocated node and the second collocated node to obtain the attribute prediction value of the current node includes: in response to the first collocated node being present in the first reference picture and the second collocated node being present in the second reference picture, determining a first difference number between a number of occupied child nodes of the first collocated node and a number of occupied child nodes of the current node according to occupancy information of the first collocated node and occupancy information of the current node; determining a second difference number between a number of occupied child nodes of the second collocated node and the number of occupied child nodes of the current node according to occupancy information of the second collocated node and the occupancy information of the current node and determining the attribute prediction value of the current node according to a relationship between the first difference number and the second difference number.

Further, in some embodiments, the operation of determining the attribute prediction value of the current node according to the relationship between the first difference number and the second difference number includes at least one of the following:
(1) in response to the first difference number being equal to the second difference number, determining the attribute prediction value of the current node according to an attribute reconstructed value of the first collocated node and an attribute reconstructed value of the second collocated node;
(2) in response to the first difference number being smaller than the second difference number, determining the attribute prediction value of the current node according to an attribute reconstructed value of the first collocated node; or
(3) in response to the first difference number being greater than the second difference number, determining the attribute prediction value of the current node according to an attribute reconstructed value of the second collocated node.

For example, in some embodiments, in a case where the first difference number is smaller than the second difference number, the attribute prediction value of the current node is equal to the attribute reconstructed value of the first collocated node.

For example, in some embodiments, in a case where the first difference number is greater than the second difference number, the attribute prediction value of the current node is equal to the attribute reconstructed value of the second collocated node.

In some embodiments, the operation that inter attribute prediction is performed on the current node according to the first collocated node and the second collocated node to obtain the attribute prediction value of the current node further includes at least one of the following:
(1) in response to the first collocated node being not present in the first reference picture and the second collocated node being present in the second reference picture, determining the attribute prediction value of the current node according to an attribute reconstructed value of the second collocated node;
(2) in response to the first collocated node being present in the first reference picture and the second collocated node being not present in the second reference picture, determining the attribute prediction value of the current node according to an attribute reconstructed value of the first collocated node; or
(3) in response to the first collocated node being not present in the first reference picture and the second collocated node being not present in the second reference picture, determining the attribute prediction value of the current node according to an attribute reconstructed value of at least one neighborhood node of the current node in the current picture.

For example, in some embodiments, in a case where the first collocated node is not present in the first reference picture and the second collocated node is present in the second reference picture, the attribute prediction value of the current node is equal to the attribute reconstructed value of the second collocated node.

For example, in some embodiments, in a case where the first collocated node is present in the first reference picture and the second collocated node is not present in the second reference picture, the attribute prediction value of the current node is equal to the attribute reconstructed value of the first collocated node.

In some embodiments, the operation of determining the attribute prediction value of the current node according to the attribute reconstructed value of the first collocated node and the attribute reconstructed value of the second collocated node includes: performing a weighting operation on the attribute reconstructed value of the first collocated node and the attribute reconstructed value of the second collocated node according to a first weighting coefficient of the attribute reconstructed value of the first collocated node and a second weighting coefficient of the attribute reconstructed value of the second collocated node, to obtain the attribute prediction value of the current node.

For example, in some embodiments, the first weighting coefficient is equal to a first numerical value, and the second weighting coefficient is equal to a second numerical value.

For example, in some other embodiments, the decoder may determine the first weighting coefficient according to an interval between an acquisition time of the current picture and an acquisition time of the first reference picture; and/or determine the second weighting coefficient according to an interval between the acquisition time of the current picture and an acquisition time of the second reference picture.

For example, in some further embodiments, the decoder may parse a bitstream to obtain the first weighting coefficient and the second weighting coefficient.

In the RAHT inter prediction transform coding scheme, the above attribute prediction value refers to the prediction value of the AC coefficient, and the above attribute reconstructed value refers to the reconstructed value of the AC coefficient. Based on this, in some embodiments, the decoding method also includes: parsing the bitstream to obtain a residual value of the AC coefficient of the current node; determining a reconstructed value of the AC coefficient of the current node according to the residual value of the AC coefficient of the current node and the prediction value of the AC coefficient of the current node; and performing an RAHT inverse transform on the reconstructed value of the AC coefficient of the current node, to obtain the attribute reconstructed value of the current node, where the attribute reconstructed value obtained by the RAHT inverse transform is not the reconstructed value of the AC coefficient.

It should be noted that in the embodiments of the present application, the method for determining the attribute prediction value of the current node in the decoding method is the same as the method for determining the attribute prediction value of the current node in the encoding method. Therefore, the technical details not disclosed in the decoding method embodiments may refer to the description of the encoding method embodiments of the present application for understanding.

An exemplary application of the embodiments of the present application in a practical application scenario is described below.

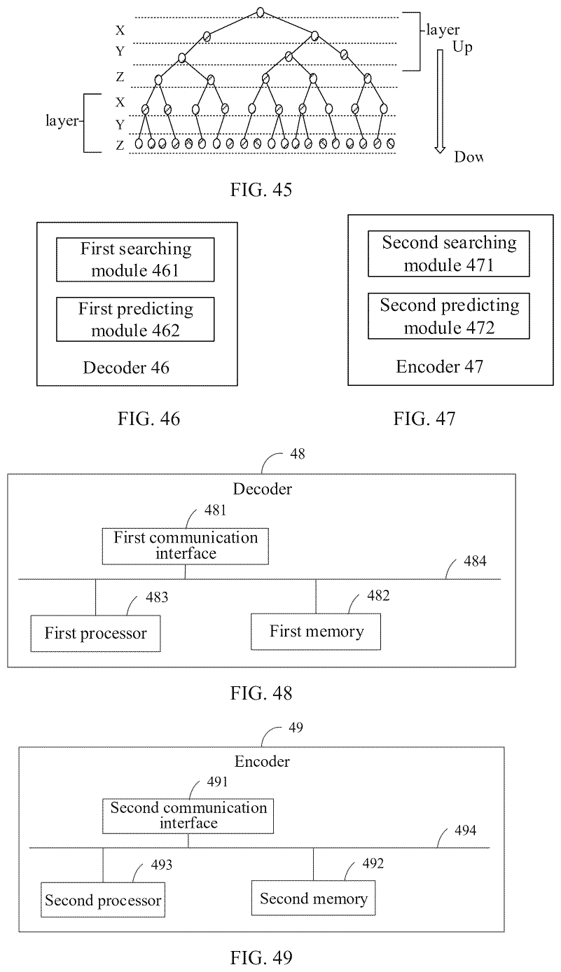

In the embodiments of the present application, the RAHT attribute coding level is first defined, and the attribute RAHT transform coding order starts from the root node and progressively partitions down to the voxel level (1×1×1), so as to complete the attribute coding and attribute reconstruction of the entire point cloud. In some embodiments, as illustrated in FIG. 45, a level obtained by performing once downsampling along a Z direction, a Y direction or an X direction is defined as a RAHT transform level, i.e., layer; secondly, based on the RAHT attribute coding level, a bidirectional predictive coding scheme is introduced. The specific algorithm is illustrated in FIG. 42.

First, when encoding/decoding is performed on the attributes of the nodes of the current level, the number of nodes to be coded/decoded and position of each node may be obtained. Secondly, for each node to be coded/decoded (i.e., the current node), 19 neighborhood nodes adjacent to the spatial position of the current node to be coded/decoded are searched by using the position of the current node to be coded/decoded, and the intra prediction value corresponding to the current node is obtained based on the attribute reconstructed values of the 19 neighborhood nodes. The collocated node may be searched in the reference picture according to the spatial position of the current node to be coded, the specific encoding side algorithm is described in 1-4 below.

1) Whether the collocated node of the current node to be coded is present in the corresponding prediction level of the reference picture is searched in the buffer of the forward reference picture by using the position of the current node to be coded, if so, the prediction value of the prediction node in the forward reference picture is assumed to be predVal1; based on the same algorithm, it is determined whether the collocated node of the current node is present in the backward reference picture, if so, the prediction value of the prediction node in the backward reference picture is assumed to be predVal2. The attribute prediction value predVal of the AC coefficient of the current node finally obtained is:

$$predVal = w 1 * predVal 1 + w 2 * predVal 2$$

Where w1 is a prediction weight of the forward reference picture, and w2 is a prediction weight of the backward reference picture. The position of the current node to be coded may be understood as the geometry information of the current node, the forward reference picture may be understood as the first reference picture, the backward reference picture may be understood as the second reference picture, predVal1 may be understood as the reconstructed value of the AC coefficient/attribute reconstructed value of the AC coefficient of the first collocated node, predVal2 may be understood as the reconstructed value of the AC coefficient/attribute reconstructed value of the AC coefficient of the second collocated node, where the attribute prediction value of the AC coefficient may also be referred to as the prediction value of the AC coefficient.

2) Otherwise, if the collocated node in the forward reference picture is present, the attribute prediction value of the AC coefficient of the current node is:

$$predVal = predVal 1$$

3) Otherwise, if the collocated node in the backward reference picture is present, the attribute prediction value of the AC coefficient of the current node is:

$$predVal = predVal 2$$

4) Otherwise, if the collocated node of the current node in the backward reference picture is not present, the attribute prediction value of the AC coefficient of the current node is the intra prediction value.

Based on the above algorithm, prediction is performed on the attributes of the AC coefficients of the N child nodes of the current node. It should be noted here that in inter prediction coding, the positions corresponding to the collocated nodes are first obtained, and then the attributes of the AC coefficients of the collocated nodes or the M child nodes in the reference picture are adopted. Secondly, when predictive coding is performed on the AC coefficient of each child node, if the attribute values of the AC coefficients of the child nodes corresponding inter are not zero, the prediction value of the AC coefficients of the corresponding child nodes are the inter prediction values; otherwise, the attribute prediction values of the AC coefficients corresponding to the current child node to be coded are the intra prediction values.

The specific algorithm at the decoding side is described in 1-4 below.

1) Whether the collocated node of the current node to be coded is present in the corresponding prediction level of the reference picture is searched in the buffer of the forward reference picture by using the position of the current node to be coded, if so, the prediction value of the prediction node in the forward reference picture is assumed to be predVal1; based on the same algorithm, it is determined whether the collocated node of the current node is present in the backward reference picture, if so, the prediction value of the prediction node in the backward reference picture is assumed to be predVal2. The attribute prediction value predVal of the AC coefficient of the current node finally obtained is:

$$predVal = w 1 * predVal 1 + w 2 * predVal 2$$

Where w1 is a prediction weight of the forward reference picture, and w2 is a prediction weight of the backward reference picture.

2) Otherwise, if the collocated node in the forward reference picture is present, the attribute prediction value of the AC coefficient of the current node is:

$$predVal = predVal 1$$

3) Otherwise, if the collocated node in the backward reference picture is present, the attribute prediction value of the AC coefficient of the current node is:

$$predVal = predVal 2$$

4) Otherwise, if the collocated node of the current node in the backward reference picture is not present, the attribute prediction value of the AC coefficient of the current node is the intra prediction value.

The algorithm similar to that at the encoding side is used to obtain the prediction values of the AC coefficients corresponding to the N child nodes of the current node to be decoded. Then, the attribute prediction residuals of the AC coefficients of different child nodes are obtained from the bitstream. Inverse quantization is performed on the prediction residuals to obtain the prediction residual reconstructed values, and the prediction residual reconstructed values are added to the prediction values to reconstruct and restore the attribute reconstructed values of the AC coefficients of the current child node. Finally, the attribute value of the point is restored based on the inverse attribute transform of RAHT.

In the above scheme, for each node to be coded, a bidirectional predictive coding algorithm is introduced. When both the collocated nodes in the forward and backward reference pictures are present, the prediction weight of the forward reference picture and the prediction weight of the backward reference picture are obtained according to the slot interval between the forward reference picture and the current picture to be coded and the slot interval between the backward reference picture and the current picture to be coded, respectively. Here, only the slot relationship of the sequence set is considered, but the distribution of the AC coefficient attributes of the node to be coded is not considered. This scheme optimizes the prediction weights of the forward and backward reference pictures. Specifically, for the attributes of each level to be coded, the encoding side obtains the optimal prediction weight value of the current level to be coded by using the rate-distortion optimization algorithm; and then, passes the prediction weight value to the decoding side. The decoding side reconstructs and restores the attribute reconstructed value of the node to be decoded by using the corresponding prediction weight and the attribute prediction value of the neighboring reference, thereby further improving the attribute coding efficiency of the point cloud.

In the embodiments of the present application, when performing inter RAHT prediction on attributes, if attribute prediction may be performed on the current level to be coded, the bidirectional prediction coding algorithm is introduced based on the RAHT attribute coding structure. For each node to be coded, the corresponding collocated nodes in the forward and backward reference pictures are obtained by the spatial position of the node to be coded, respectively, and then, the attribute prediction value of the AC coefficient of the current node to be coded is obtained by using the collocated nodes. Based on such algorithm, the attributes of the AC coefficients of the forward and backward reference pictures may be comprehensively considered, so that the slot (temporal) redundancy characteristics between neighboring pictures in the forward and backward directions may be better removed, thereby further improving the attribute coding efficiency of the point cloud. Table 2 shows the coding efficiency of attributes. As shown in Table 2, it can be seen that after the RAHT bidirectional inter prediction coding algorithm is introduced, for sequences of attribute adopting inter prediction coding attributes, the BPP (bits per point) of attribute coding is reduced by about 1.75%, which significantly improves the coding efficiency of point cloud attributes.

TABLE 2

| Frame-Idx | anchor | proposal | bpp |
|---|---|---|---|
| 0 | 21376 | 21126 | 98.8% |
| 1 | 18313 | 18061 | 98.6% |
| 2 | 17933 | 17581 | 98.0% |
| 3 | 17745 | 17125 | 96.5% |
| 4 | 18151 | 18486 | 101.8% |
| 5 | 17902 | 17190 | 96.0% |
| 6 | 17500 | 17063 | 97.5% |
| 7 | 18072 | 17867 | 98.8% |

In the embodiments of the present application, when performing RAHT prediction coding on attributes, inter prediction coding is performed on the attributes of each node, and RAHT bidirectional prediction coding structure is introduced. For each node to be coded, the corresponding collocated nodes in the forward and backward reference pictures are obtained by using the spatial position of the node to be coded, respectively; and then, according to the different situations of the forward and backward reference pictures, inter prediction coding is performed on the attributes of the current node to be coded. Finally, the decoding side obtains the attribute prediction value of the corresponding node based on the same algorithm, and restores and obtains the attribute reconstructed value of the current node to be decoded by using the attribute prediction value and attribute prediction residual of the corresponding node. In this scheme, the focus is on introducing a bidirectional inter prediction coding algorithm when performing encoding or decoding on the attributes of each node of each RAHT coding, the redundancy characteristics of the attributes between neighboring pictures may be further removed by referring to the reconstructed attribute values of the forward reference node and the backward reference node. The algorithm does not limit the prediction weights of the forward and backward reference nodes. For example, the inter prediction weights of different prediction nodes may be determined according to the slot intervals of the forward and backward reference pictures, or the weights of the forward and backward reference nodes of the current node may be adaptively obtained according to the spatial position of each node and the attribute distribution of the prediction node.

(1) In this scheme, the attribute bidirectional inter prediction mode may be further modified.

In the above scheme, the forward and backward reference nodes are obtained by using the node to be coded, and then the inter attribute prediction value of the current node to be coded is obtained according to certain conditions. In this scheme, the inter attribute prediction value of the prediction node is further optimized as follows.

It is assumed that the occupancy information of the current node to be coded is “occupancy”, and the corresponding prediction nodes in the forward reference picture are obtained by using the spatial position of the current node to be coded. It is assumed that the occupancy information of the prediction node is “prevOccupancy”, and the corresponding prediction node in the forward reference picture is obtained based on the same algorithm. It is assumed that the reconstructed value of the AC coefficient of the prediction child node stored in the forward reference picture is “predVal1”, the occupancy information of the prediction node is “backOccupancy”, and the reconstructed value of the AC coefficient of the prediction child node stored in the backward reference picture is “predVal2”, then the prediction value of the current node is the following.

1) If two collocated prediction nodes are present, the difference number between the occupancy information of the current node to be coded and the occupancy information of the forward prediction node is determined, the difference number is assumed to be N1 (i.e., the first difference number), and the difference number between the occupancy information of the backward reference picture and the occupancy information of the current node to be coded is N2 (i.e., the second difference number). Then:
1) when N1 is less than N2, the attribute prediction value predVal of the AC coefficient of the current node is:

$$predVal = predVal 1$$

2) when N1 is greater than N2, the attribute prediction value predVal of the AC coefficient of the current node is:

$$predVal = predVal 2$$

3) when N1 is equal to N2, the attribute prediction value predVal of the AC coefficient attribute of the current node is:

$$predVal = w 1 * predVal 1 + w 2 * predVal 2$$

where w1 is a prediction weight of the forward reference picture, and w2 is a prediction weight of the backward reference picture.

2) Otherwise, if the collocated node in the forward reference picture is present, the attribute prediction value predVal of the AC coefficient of the current node is:

$$predVal = predVal 1$$

3) Otherwise, if the collocated node in the backward reference picture is present, the attribute prediction value predVal of the AC coefficient of the current node is:

$$predVal = predVal 2$$

4) Otherwise, if the collocated node of the current node in the backward reference picture is not present, the attribute prediction value predVal of the AC coefficient of the current node is the intra prediction value.

It should be noted that although the various steps of the method in the present application are described in a specific order in the drawings, this does not require or imply that the various steps must be performed in this specific order, or that all of the various steps shown must be performed to achieve the desired results. Additionally or alternatively, certain steps may be omitted, multiple steps may be combined into one step, and/or one step may be decomposed into multiple steps, or the like; or, steps in different embodiments may be combined into a new technical solution.

The embodiments of the present application provide a decoder. FIG. 46 is a schematic structural diagram of a decoder provided by the embodiments of the present application. As illustrated in FIG. 46, the decoder 46 includes: a first searching module 461, configured to search for a first collocated node of a current node in a first reference picture and search for a second collocated node of the current node in a second reference picture according to geometry information of the current node in a current picture; and a first predicting module 462, configured to perform inter attribute prediction on the current node according to the first collocated node and the second collocated node, to obtain an attribute prediction value of the current node.

In some embodiments, the first predicting module 462 is configured to determine, in response to the first collocated node being present in the first reference picture and the second collocated node being present in the second reference picture, the attribute prediction value of the current node according to an attribute reconstructed value of the first collocated node and an attribute reconstructed value of the second collocated node.

In some embodiments, the first predicting module 462 is configured to determine, in response to the first collocated node being present in the first reference picture and the second collocated node being present in the second reference picture, determining a first difference number between a number of occupied child nodes of the first collocated node and a number of occupied child nodes of the current node according to occupancy information of the first collocated node and occupancy information of the current node; determine a second difference number between a number of occupied child nodes of the second collocated node and the number of occupied child nodes of the current node according to occupancy information of the second collocated node and the occupancy information of the current node; and determine the attribute prediction value of the current node according to a relationship between the first difference number and the second difference number.

In some embodiments, the operation of determining the attribute prediction value of the current node according to the relationship between the first difference number and the second difference number includes: in response to the first difference number being equal to the second difference number, determining the attribute prediction value of the current node according to an attribute reconstructed value of the first collocated node and an attribute reconstructed value of the second collocated node.

In some embodiments, the operation of determining the attribute prediction value of the current node according to the relationship between the first difference number and the second difference number includes: in response to the first difference number being smaller than the second difference number, determining the attribute prediction value of the current node according to an attribute reconstructed value of the first collocated node.

In some embodiments, in response to the first difference number being smaller than the second difference number, the attribute prediction value of the current node is equal to the attribute reconstructed value of the first collocated node.

In some embodiments, the operation of determining the attribute prediction value of the current node according to the relationship between the first difference number and the second difference number includes: in response to the first difference number being greater than the second difference number, determining the attribute prediction value of the current node according to an attribute reconstructed value of the second collocated node.

In some embodiments, in response to the first difference number being greater than the second difference number, the attribute prediction value of the current node is equal to the attribute reconstructed value of the second collocated node.

In some embodiments, the first predicting module 462 is further configured to determine, in response to the first collocated node being not present in the first reference picture and the second collocated node being present in the second reference picture, the attribute prediction value of the current node according to an attribute reconstructed value of the second collocated node.

In some embodiments, in response to the first collocated node being not present in the first reference picture and the second collocated node being present in the second reference picture, the attribute prediction value of the current node is equal to the attribute reconstructed value of the second collocated node.

In some embodiments, the first predicting module 462 is further configured to determine, in response to the first collocated node being present in the first reference picture and the second collocated node being not present in the second reference picture, the attribute prediction value of the current node according to an attribute reconstructed value of the first collocated node.

In some embodiments, in response to the first collocated node being present in the first reference picture and the second collocated node being not present in the second reference picture, the attribute prediction value of the current node is equal to the attribute reconstructed value of the first collocated node.

In some embodiments, the first prediction module 462 is further configured to determine, in response to the first collocated node being not present in the first reference picture and the second collocated node being not present in the second reference picture, the attribute prediction value of the current node according to an attribute reconstructed value of at least one neighborhood node of the current node in the current picture.

In some embodiments, the operation of determining the attribute prediction value of the current node according to the attribute reconstructed value of the first collocated node and the attribute reconstructed value of the second collocated node includes: performing a weighting operation on the attribute reconstructed value of the first collocated node and the attribute reconstructed value of the second collocated node according to a first weighting coefficient of the attribute reconstructed value of the first collocated node and a second weighting coefficient of the attribute reconstructed value of the second collocated node, to obtain the attribute prediction value of the current node.

In some embodiments, the first weighting coefficient is equal to a first numerical value, and the second weighting coefficient is equal to a second numerical value.

In some embodiments, the first predicting module 462 is further configured to determine the first weighting coefficient according to an interval between an acquisition time of the current picture and an acquisition time of the first reference picture.

In some embodiments, the first predicting module 462 is further configured to determine the second weighting coefficient according to an interval between an acquisition time of the current picture and an acquisition time of the second reference picture.

In some embodiments, the decoder 46 further includes a parsing module, configured to parse a bitstream to obtain the first weighting coefficient and the second weighting coefficient.

In some embodiments, the attribute prediction value of the current node is a prediction value of an alternating current (AC) coefficient of the current node; the decoder 46 further includes a parsing module, configured to a bitstream to obtain a residual value of the AC coefficient of the current node; determine a reconstructed value of the AC coefficient of the current node according to the residual value of the AC coefficient of the current node and the prediction value of the AC coefficient of the current node; and perform an inverse region adaptive hierarchal transform (RAHT) on the reconstructed value of the AC coefficient of the current node, to obtain the attribute reconstructed value of the current node.

The description of the above decoder embodiments is similar to the description of the above encoding/decoding method embodiments, and has similar beneficial effects as the encoding/decoding method embodiments. For technical details not disclosed in the decoder embodiments of the present application, please refer to the description of the encoding/decoding method embodiments of the present application for understanding.

The embodiments of the present application provide an encoder, and FIG. 47 is a schematic structural diagram of an encoder provided by the embodiments of the present application. As illustrated in FIG. 47, the encoder 47 includes: a second searching module 471, configured to search for a first collocated node of a current node in a first reference picture and search for a second collocated node of the current node in a second reference picture according to geometry information of the current node in a current picture; and a second predicting module 472, configured to perform inter attribute prediction on the current node according to the first collocated node and the second collocated node, to obtain an attribute prediction value of the current node.

In some embodiments, the second predicting module 472 is configured to determine, inresponsetothefirstcollocatednodebeingpresentinthefirstreferencepicture and the second collocated node being present in the second reference picture, the attribute prediction value of the current node according to an attribute reconstructed value of the first collocated node and an attribute reconstructed value of the second collocated node.

In some embodiments, the second predicting module 472 is configured to determine, in response to the first collocated node being present in the first reference picture and the second collocated node being present in the second reference picture, a first difference number between a number of occupied child nodes of the first collocated node and a number of occupied child nodes of the current node according to occupancy information of the first collocated node and occupancy information of the current node; determine a second difference number between a number of occupied child nodes of the second collocated node and the number of occupied child nodes of the current node according to occupancy information of the second collocated node and the occupancy information of the current node; and determine the attribute prediction value of the current node according to a relationship between the first difference number and the second difference number.

In some embodiments, the operation of determining the attribute prediction value of the current node according to the relationship between the first difference number and the second difference number includes: in response to the first difference number being equal to the second difference number, determining the attribute prediction value of the current node according to an attribute reconstructed value of the first collocated node and an attribute reconstructed value of the second collocated node.

In some embodiments, the operation of determining the attribute prediction value of the current node according to the relationship between the first difference number and the second difference number includes: in response to the first difference number being smaller than the second difference number, determining the attribute prediction value of the current node according to an attribute reconstructed value of the first collocated node.

In some embodiments, in response to the first difference number being smaller than the second difference number, the attribute prediction value of the current node is equal to the attribute reconstructed value of the first collocated node.

In some embodiments, the operation of determining the attribute prediction value of the current node according to the relationship between the first difference number and the second difference number includes: in response to the first difference number being greater than the second difference number, determining the attribute prediction value of the current node according to an attribute reconstructed value of the second collocated node.

In some embodiments, in response to the first difference number being greater than the second difference number, the attribute prediction value of the current node is equal to the attribute reconstructed value of the second collocated node.

In some embodiments, the second predicting module 472 is further configured to determine, in response to the first collocated node being not present in the first reference picture and the second collocated node being present in the second reference picture, the attribute prediction value of the current node according to an attribute reconstructed value of the second collocated node.

In some embodiments, in response to the first collocated node being not present in the first reference picture and the second collocated node being present in the second reference picture, the attribute prediction value of the current node is equal to the attribute reconstructed value of the second collocated node.

In some embodiments, the second predicting module 472 is further configured to determine, in response to the first collocated node being present in the first reference picture and the second collocated node being not present in the second reference picture, the attribute prediction value of the current node according to an attribute reconstructed value of the first collocated node.

In some embodiments, in response to the first collocated node being present in the first reference picture and the second collocated node being not present in the second reference picture, the attribute prediction value of the current node is equal to the attribute reconstructed value of the first collocated node.

In some embodiments, the second predicting module 472 is further configured to determine, in response to the first collocated node being not present in the first reference picture and the second collocated node being not present in the second reference picture, the attribute prediction value of the current node according to an attribute reconstructed value of at least one neighborhood node of the current node in the current picture.

In some embodiments, the operation of determining the attribute prediction value of the current node according to the attribute reconstructed value of the first collocated node and the attribute reconstructed value of the second collocated node includes: performing a weighting operation on the attribute reconstructed value of the first collocated node and the attribute reconstructed value of the second collocated node according to a first weighting coefficient of the attribute reconstructed value of the first collocated node and a second weighting coefficient of the attribute reconstructed value of the second collocated node, to obtain the attribute prediction value of the current node.

In some embodiments, the first weighting coefficient is equal to a first numerical value, and the second weighting coefficient is equal to a second numerical value.

In some embodiments, the second predicting module 472 is further configured to determine the first weighting coefficient according to an interval between an acquisition time of the current picture and an acquisition time of the first reference picture.

In some embodiments, the second predicting module 472 is further configured to determine the second weighting coefficient according to an interval between an acquisition time of the current picture and an acquisition time of the second reference picture.

In some embodiments, the second predicting module 472 is further configured to determine a respective rate-distortion cost for each of multiple candidate weighting coefficient groups, where the candidate weighting coefficient group includes a first candidate weighting coefficient of the attribute reconstructed value of the first collocated node and a second candidate weighting coefficient of the attribute reconstructed value of the second collocated node; select a candidate weighting coefficient group with a smallest rate-distortion cost from the multiple candidate weighting coefficient groups; and take a first candidate weighting coefficient in the candidate weighting coefficient group with the smallest rate-distortion cost as the first weighting coefficient, and taking a second candidate weighting coefficient in the candidate weighting coefficient group with the smallest rate-distortion cost as the second weighting coefficient.

In some embodiments, the encoder 47 further includes an encoding module, configured to signal the first weighting coefficient and the second weighting coefficient into a bitstream.

In some embodiments, the encoder 47 further includes an encoding module, configured to determine an attribute residual value of the current node according to the attribute prediction value of the current node; and generate a bitstream according to the attribute residual value of the current node.

In some embodiments, the attribute prediction value of the current node is a prediction value of an alternating current (AC) coefficient of the current node, and the attribute residual value of the current node is a residual value of the AC coefficient of the current node.

The description of the above encoder embodiments is similar to the description of the above encoding method embodiments, and has similar beneficial effects as the encoding method embodiments. For technical details not disclosed in the encoder embodiments of the present application, please refer to the description of the encoding method embodiments of the present application for understanding.

It should be noted that the division of modules by the encoder/decoder described in the embodiments of the present application is schematic and is only a logical function division. There may be other division methods in actual implementation. In addition, various functional units in various embodiments of the present application may be integrated into one processing unit, or may exist physically separately, or two or more units may be integrated into one unit. The above-mentioned integrated unit may be implemented in the form of hardware or in the form of software functional units, or may be implemented in the form of a combination of software and hardware.

It should be noted that, in the embodiments of the present application, if the described functions are implemented in a form of a software functional unit and sold or used as an independent product, they may be stored in anon-transitory computer readable storage medium. Based on this understanding, the technical solution of the present application essentially, or a part of the technical solution that contributes to the prior art, or a part of the technical solution, may be embodied in a form of a software product, and the computer software product is stored in a storage medium, and includes a plurality of instructions for enabling an electronic device to perform all or some of steps of the methods described in the various embodiments of the present application. And, the storage medium mentioned above includes a USB flash drive (U disk), a mobile hard disk, a read-only memory (ROM), a diskette, or an optical disk, and various mediums that may store program codes. Thus, the embodiments of the present application are not limited to any specific combination of hardware and software.

The embodiments of the present application provide a non-transitory computer-readable storage medium, where the non-transitory computer-readable storage medium stores a computer program, and when the computer program is executed, the encoding method or the decoding method as described in the embodiments of the present application is implemented.

The embodiments of the present application provide a decoder, as illustrated in FIG. 48, the decoder 48 includes: a first communication interface 481, a first memory 482 and a first processor 483; the various components are coupled together through a first bus system 484. It may be understood that the first bus system 484 is configured to achieve connection and communication between these components. In addition to the data bus, the first bus system 484 further includes a power bus, a control bus, and a status signal bus. However, for the sake of clarity, the various buses are labeled as the first bus system 484 in FIG. 48. The first communication interface 481 is configured to receive and transmit signals during the process of transmitting and receiving information with other external network elements; the first memory 482 is configured to store the computer program that can be run on the first processor 483; and the first processor 483 is configured to perform the encoding method described in the embodiments of the present application when running the computer program.

It may be understood that the first memory 482 in the embodiments of the present application may be a volatile memory or a non-volatile memory, or may include both volatile and non-volatile memories. The non-volatile memory may be a read-only memory (ROM), a programmable ROM (PROM), an erasable PROM (EPROM), an electrically EPROM (EEPROM), or a flash memory. The volatile memory may be a random access memory (RAM), which acts as external cache memory. By way of example and not limitation, many forms of RAM are available, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM), or a direct rambus RAM (DRRAM). The first memory 482 of the systems and methods described herein is intended to include, but not be limited to, these and any other suitable types of memories.

The first processor 483 may be an integrated circuit chip with signal processing capabilities. During implementation, various step of the above method may be completed by an integrated logic circuit of hardware in the first processor 483 or by instructions in software form. The first processor 483 may be a general-purpose processor, a digital signal processor (DSP), an application specific integrated circuit (ASIC), a field programmable gate array (FPGA), or other programmable logic devices, discrete gate or transistor logic devices, or discrete hardware components. The various methods, steps and logic diagrams disclosed in the embodiments of the present application may be implemented or executed. The general-purpose processor may be a microprocessor, or the processor may be any traditional processor or the like. The steps of the method disclosed in the embodiments of the present application may be directly implemented by a hardware decoding processor, or implemented by a combination of hardware and software modules in the decoding processor. The software module may be located in a storage medium mature in the art, such as a random access memory, a flash memory, a read-only memory, a programmable read-only memory, or an electrically erasable programmable memory, a register, or the like. The storage medium is located in the first memory 482, and the first processor 483 reads the information in the first memory 482 and completes the steps of the above method in combination with its hardware.

It will be understood that the embodiments described herein may be implemented by hardware, software, firmware, middleware, microcode, or a combination thereof. For hardware implementation, the processing unit may be implemented in one or more application specific integrated circuits (ASICs), digital signal processors (DSPs), DSP devices (DSPDs), programmable logic devices (PLDs), field-programmable gate arrays (FPGAs), general-purpose processors, controllers, microcontrollers, microprocessors, other electronic units for performing the functions described in the present application, or combinations thereof. For software implementation, the technology described in the present application may be implemented through modules (e.g., procedures, functions) that perform the functions described in the present application. The software codes may be stored in a memory and executed by a processor. The memory may be implemented within the processor or external to the processor.

Optionally, as another embodiment, the first processor 483 is further configured to perform any of the aforementioned encoding method embodiments when running the computer program.

The embodiments of the present application provide an encoder, as illustrated in FIG. 49, the encoder 49 includes: a second communication interface 491, a second memory 492 and a second processor 493; the various components are coupled together through a second bus system 494. It may be understood that the second bus system 494 is configured to achieve connection and communication between these components. In addition to the data bus, the second bus system 494 further includes a power bus, a control bus, and a status signal bus. However, for the sake of clarity, the various buses are labeled as the second bus system 494 in FIG. 49. The second communication interface 491 is configured to receive and transmit signals during the process of transmitting and receiving information with other external network elements; the second memory 492 is configured to store the computer program that may be run on the second processor 493; and the second processor 493 is configured to perform the decoding method described in the embodiments of the present application when running the computer program.

It may be understood that the hardware functions of the second memory 492 are similar to the hardware functions of the first memory 482, and the hardware functions of the second processor 493 are similar to the hardware functions of the first processor 483; they will not be repeated here.

The embodiments of the present application further provide a bitstream, which is obtained by using the above encoding method.

The embodiments of the present application provide an electronic device. The electronic device includes: a processor, configured to execute a computer program; and a non-transitory computer-readable storage medium, where the non-transitory computer-readable storage medium stores a computer program, and when the computer program is executed by the processor, the encoding method and/or decoding method described in the embodiments of the present application is implemented. The electronic device may be any type of device with video encoding and/or video decoding capabilities, for example, the electronic device may be a mobile phone, a tablet computer, a laptop computer, a personal computer, a television, a projection device, or a monitoring device.

It should be pointed out here that the description of the above storage medium and device embodiments is similar to the description of the above method embodiments, and has similar beneficial effects as the method embodiments. For technical details not disclosed in the storage medium, storage medium and device embodiments of the present application, please refer to the description of the method embodiments of the present application for understanding.

It should be understood that reference throughout the present specification to “one embodiment” or “an embodiment” or “some embodiments” means that a particular feature, structure, or characteristic related to the embodiment is included in at least one embodiment of the present application. Thus, the appearances of “in one embodiment” or “in an embodiment” or “in some embodiments” in various places throughout the specification are not necessarily referring to the same embodiment. Furthermore, the particular features, structures, or characteristics may be combined in any suitable manner in one or more embodiments. It should be understood that in the various embodiments of the present application, the magnitude of the serial numbers of the above-mentioned processes does not mean the order of execution. The execution order of various processes should be determined by its function and internal logic, and should not constitute any limitation on the implementation process of the embodiments of the present application. The serial numbers of the above embodiments of the present application are for description only and do not represent the advantages or disadvantages of the embodiments. The above description of the various embodiments tends to emphasize the differences between the various embodiments. The same or similar aspects may be referenced with each other and will not be repeated herein for the sake of brevity.

The term “and/or” in the present application is merely a description of the association relationship of associated objects, indicating that there may be three relationships. For example, an object A and/or an object B may mean three cases: the object A alone, the objects A and B both, and the object B alone.

It should be noted that, in the present application, the terms “comprises”, “includes”, “contains” or any other variations thereof are intended to cover non-exclusive inclusion, so that a process, method, article or apparatus that includes a series of elements includes not only those elements, but also other elements not explicitly listed, or further includes elements that are inherent to such process, method, article or apparatus. Without further constraints, an element defined by the phrase “comprises a . . . ” does not exclude the existence of other identical elements in the process, method, article or apparatus that includes the element.

In the several embodiments provided by the present application, it should be understood that, the disclosed devices and methods may be implemented in other ways. The embodiments described above are merely schematic, for example, division of the modules is only division of logical functions, and there may be other division methods in an actual implementation, for example, multiple modules or components may be combined, or may be integrated into another system, or some features may be ignored or not executed. In addition, the coupling or direct coupling or communicative connection between each other as shown or discussed may be indirect coupling or communicative connection of devices or modules via some interfaces, which may be electrical, mechanical, or in other forms.

The modules illustrated as separate components may be or may not be physically separated, and the components shown as modules may be or may not be physical modules, that is, they may be located in one place, or may be distributed onto a plurality of network units. A part or all of the modules may be selected according to actual needs, to implement the purpose of the schemes of the embodiments.

In addition, the various functional modules in the various embodiments of the present application may be integrated into one processing unit, or the various modules may exist physically separately, or two or more modules may be integrated into one unit. The above-mentioned integrated modules may be implemented in the form of hardware or in the form of hardware plus software functional units.

Those skilled in the art will understand that, all or part of the steps of the above-mentioned method embodiments may be completed by hardware related to program instructions, and the aforementioned program may be stored in a non-transitory computer-readable storage medium. When the program is executed, the steps of the above-mentioned method embodiments are performed; and the aforementioned storage medium includes: a mobile storage device, a read-only memory (ROM), a magnetic disk or an optical disk, and other medium that may store program codes. Alternatively, if the above-mentioned integrated units of the present application are implemented in the form of a software function module and sold or used as an independent product, it may also be stored in a non-transitory computer-readable storage medium. Based on this understanding, the technical solutions of the embodiments of the present application may essentially or the part that contributes to the relevant technology may be embodied in the form of a software product. The computer software product is stored in a storage medium and includes a number of instructions for enabling an electronic device to execute all or part of the methods described in various embodiments of the present application. The aforementioned storage mediums include: mobile storage devices, ROMs, magnetic disks, optical disks, and other mediums that may store program codes.

The methods disclosed in several method embodiments provided in the present disclosure may be arbitrarily combined without conflict to obtain new method embodiments. The features disclosed in several product embodiments provided in the present disclosure may be arbitrarily combined without conflict to obtain new product embodiments. The features disclosed in several method or device embodiments provided in the present disclosure may be arbitrarily combined without conflict to obtain new method embodiments or device embodiments.

In a first clause, provided is a decoding method, where the method is applied to a decoder and includes: searching for a first collocated node of a current node in a first reference picture and searching for a second collocated node of the current node in a second reference picture according to geometry information of the current node in a current picture; and performing inter attribute prediction on the current node according to the first collocated node and the second collocated node, to obtain an attribute prediction value of the current node.

In a second clause, according to method of the first clause, where performing inter attribute prediction on the current node according to the first collocated node and the second collocated node, to obtain the attribute prediction value of the current node includes: in response to the first collocated node being present in the first reference picture and the second collocated node being present in the second reference picture, determining the attribute prediction value of the current node according to an attribute reconstructed value of the first collocated node and an attribute reconstructed value of the second collocated node.

In a third clause, according to the method of the first clause, where performing inter attribute prediction on the current node according to the first collocated node and the second collocated node, to obtain the attribute prediction value of the current node includes: in response to the first collocated node being present in the first reference picture and the second collocated node being present in the second reference picture, determining a first difference number between a number of occupied child nodes of the first collocated node and a number of occupied child nodes of the current node according to occupancy information of the first collocated node and occupancy information of the current node; determining a second difference number between a number of occupied child nodes of the second collocated node and the number of occupied child nodes of the current node according to occupancy information of the second collocated node and the occupancy information of the current node; and determining the attribute prediction value of the current node according to a relationship between the first difference number and the second difference number.

In a fourth clause, according to the method of the third clause, where determining the attribute prediction value of the current node according to the relationship between the first difference number and the second difference number includes: in response to the first difference number being equal to the second difference number, determining the attribute prediction value of the current node according to an attribute reconstructed value of the first collocated node and an attribute reconstructed value of the second collocated node.

In a fifth clause, according to the method of the third clause, where determining the attribute prediction value of the current node according to the relationship between the first difference number and the second difference number includes: in response to the first difference number being smaller than the second difference number, determining the attribute prediction value of the current node according to an attribute reconstructed value of the first collocated node.

In a sixth clause, according to the method of the fifth clause, wherein response to the first difference number being smaller than the second difference number, the attribute prediction value of the current node is equal to the attribute reconstructed value of the first collocated node.

In a seventh clause, according to the method of third clause, where determining the attribute prediction value of the current node according to the relationship between the first difference number and the second difference number includes: in response to the first difference number being greater than the second difference number, determining the attribute prediction value of the current node according to an attribute reconstructed value of the second collocated node.

In an eighth clause, according to the method of the seventh clause, in response to the first difference number being greater than the second difference number, the attribute prediction value of the current node is equal to the attribute reconstructed value of the second collocated node.

In a ninth clause, according to the method of any one of the first to eighth clauses, where performing inter attribute prediction on the current node according to the first collocated node and the second collocated node, to obtain the attribute prediction value of the current node includes: in response to the first collocated node being not present in the first reference picture and the second collocated node being present in the second reference picture, determining the attribute prediction value of the current node according to an attribute reconstructed value of the second collocated node.

In a tenth clause, according to the method of the ninth clause, in response to the first collocated node being not present in the first reference picture and the second collocated node being present in the second reference picture, the attribute prediction value of the current node is equal to the attribute reconstructed value of the second collocated node.

In an eleventh clause, according to the method ofany one of the first to eighth clauses, where performing inter attribute prediction on the current node according to the first collocated node and the second collocated node, to obtain the attribute prediction value of the current node includes: in response to the first collocated node being present in the first reference picture and the second collocated node being not present in the second reference picture, determining the attribute prediction value of the current node according to an attribute reconstructed value of the first collocated node.

In a twelfth clause, according to the method of the eleventh clause, in response to the first collocated node being present in the first reference picture and the second collocated node being not present in the second reference picture, the attribute prediction value of the current node is equal to the attribute reconstructed value of the first collocated node.

In a thirteenth clause, according to the method ofany one of the first to eighth clauses, where performing inter attribute prediction on the current node according to the first collocated node and the second collocated node, to obtain the attribute prediction value of the current node includes: in response to the first collocated node being not present in the first reference picture and the second collocated node being not present in the second reference picture, determining the attribute prediction value of the current node according to an attribute reconstructed value of at least one neighborhood node of the current node in the current picture.

In a fourteenth clause, according to the method of second or fourth clause, where determining the attribute prediction value of the current node according to the attribute reconstructed value of the first collocated node and the attribute reconstructed value of the second collocated node includes: performing a weighting operation on the attribute reconstructed value of the first collocated node and the attribute reconstructed value of the second collocated node according to a first weighting coefficient of the attribute reconstructed value of the first collocated node and a second weighting coefficient of the attribute reconstructed value of the second collocated node, to obtain the attribute prediction value of the current node.

In a fifteenth clause, according to the method of the fourteenth clause, the first weighting coefficient is equal to a first numerical value, and the second weighting coefficient is equal to a second numerical value.

In a sixteenth clause, according to the method of the fourteenth clause, the method further includes: determining the first weighting coefficient according to an interval between an acquisition time of the current picture and an acquisition time of the first reference picture.

In a seventeenth clause, according to the method of the fourteenth clause, the method further includes: determining the second weighting coefficient according to an interval between an acquisition time of the current picture and an acquisition time of the second reference picture.

In an eighteenth clause, according to the method of the fourteenth clause, the method further includes: parsing a bitstream to obtain the first weighting coefficient and the second weighting coefficient.

In a nineteenth clause, according to the method of the first clause, the attribute prediction value of the current node is a prediction value of an AC coefficient of the current node; and the method further includes: parsing a bitstream to obtain a residual value of the AC coefficient of the current node; determining a reconstructed value of the AC coefficient of the current node according to the residual value of the AC coefficient of the current node and the prediction value of the AC coefficient of the current node; and performing an inverse RAHT on the reconstructed value of the AC coefficient of the current node, to obtain the attribute reconstructed value of the current node.

In a twentieth clause, provided is an encoding method, where the method is applied to an encoder and includes: searching for a first collocated node of a current node in a first reference picture and searching for a second collocated node of the current node in a second reference picture according to geometry information of the current node in a current picture; and performing inter attribute prediction on the current node according to the first collocated node and the second collocated node, to obtain an attribute prediction value of the current node.

In a twenty-first clause, according to the method of the twentieth clause, where performing inter attribute prediction on the current node according to the first collocated node and the second collocated node, to obtain the attribute prediction value of the current node includes: in response to the first collocated node being present in the first reference picture and the second collocated node being present in the second reference picture, determining the attribute prediction value of the current node according to an attribute reconstructed value of the first collocated node and an attribute reconstructed value of the second collocated node.

In a twenty-second clause, according to the method of the twentieth clause, where performing inter attribute prediction on the current node according to the first collocated node and the second collocated node, to obtain the attribute prediction value of the current node includes: in response to the first collocated node being present in the first reference picture and the second collocated node being present in the second reference picture, determining a first difference number between a number of occupied child nodes of the first collocated node and a number of occupied child nodes of the current node according to occupancy information of the first collocated node and occupancy information of the current node; determining a second difference number between a number of occupied child nodes of the second collocated node and the number of occupied child nodes of the current node according to occupancy information of the second collocated node and the occupancy information of the current node; and determining the attribute prediction value of the current node according to a relationship between the first difference number and the second difference number.

In a twenty-third clause, according to the method of the twenty-second clause, where determining the attribute prediction value of the current node according to the relationship between the first difference number and the second difference number includes: in response to the first difference number being equal to the second difference number, determining the attribute prediction value of the current node according to an attribute reconstructed value of the first collocated node and an attribute reconstructed value of the second collocated node.

In a twenty-fourth clause, according to the method of the twenty-second clause, where determining the attribute prediction value of the current node according to the relationship between the first difference number and the second difference number includes: in response to the first difference number being smaller than the second difference number, determining the attribute prediction value of the current node according to an attribute reconstructed value of the first collocated node.

In a twenty-fifth clause, according to the method of the twenty-fourth clause, in response to the first difference number being smaller than the second difference number, the attribute prediction value of the current node is equal to the attribute reconstructed value of the first collocated node.

In a twenty-sixth clause, according to the method of the twenty-second clause, where determining the attribute prediction value of the current node according to the relationship between the first difference number and the second difference number includes: in response to the first difference number being greater than the second difference number, determining the attribute prediction value of the current node according to an attribute reconstructed value of the second collocated node.

In a twenty-seventh clause, according to the method of the twenty-sixth clause, in response to the first difference number being greater than the second difference number, the attribute prediction value of the current node is equal to the attribute reconstructed value of the second collocated node.

In a twenty-eighth clause, according to the method of any one of the twentieth to twenty-seventh clauses, where performing inter attribute prediction on the current node according to the first collocated node and the second collocated node, to obtain the attribute prediction value of the current node includes: in response to the first collocated node being not present in the first reference picture and the second collocated node being present in the second reference picture, determining the attribute prediction value of the current node according to an attribute reconstructed value of the second collocated node.

In a twenty-ninth clause, according to the method of the twenty-eighth clause, in response to the first collocated node being not present in the first reference picture and the second collocated node being present in the second reference picture, the attribute prediction value of the current node is equal to the attribute reconstructed value of the second collocated node.

In a thirtieth clause, according to the method of any one of the twentieth to twenty-seventh clauses, where performing inter attribute prediction on the current node according to the first collocated node and the second collocated node, to obtain the attribute prediction value of the current node includes: in response to the first collocated node being present in the first reference picture and the second collocated node being not present in the second reference picture, determining the attribute prediction value of the current node according to an attribute reconstructed value of the first collocated node.

In a thirty-first clause, according to the method of the thirtieth clause, in response to the first collocated node being present in the first reference picture and the second collocated node being not present in the second reference picture, the attribute prediction value of the current node is equal to the attribute reconstructed value of the first collocated node.

In a thirty-second clause, according to the method of any one of the twentieth to twenty-seventh clauses, where performing inter attribute prediction on the current node according to the first collocated node and the second collocated node, to obtain the attribute prediction value of the current node includes: in response to the first collocated node being not present in the first reference picture and the second collocated node being not present in the second reference picture, determining the attribute prediction value of the current node according to an attribute reconstructed value of at least one neighborhood node of the current node in the current picture.

In a thirty-third clause, according to the method of the twenty-first or twenty-third clause, where determining the attribute prediction value of the current node according to the attribute reconstructed value of the first collocated node and the attribute reconstructed value of the second collocated node includes: performing a weighting operation on the attribute reconstructed value of the first collocated node and the attribute reconstructed value of the second collocated node according to a first weighting coefficient of the attribute reconstructed value of the first collocated node and a second weighting coefficient of the attribute reconstructed value of the second collocated node, to obtain the attribute prediction value of the current node.

In a thirty-fourth clause, according to the method of the thirty-third clause, the first weighting coefficient is equal to a first numerical value, and the second weighting coefficient is equal to a second numerical value.

In a thirty-fifth clause, according to the method of the thirty-third clause, the method further includes: determining the first weighting coefficient according to an interval between an acquisition time of the current picture and an acquisition time of the first reference picture.

In a thirty-sixth clause, according to the method of the thirty-third clause, the method further includes: determining the second weighting coefficient according to an interval between an acquisition time of the current picture and an acquisition time of the second reference picture.

In a thirty-seventh clause, according to the method of the thirty-third clause, the method further includes: determining a respective rate-distortion cost for each of multiple candidate weighting coefficient groups, where the candidate weighting coefficient group includes a first candidate weighting coefficient of the attribute reconstructed value of the first collocated node and a second candidate weighting coefficient of the attribute reconstructed value of the second collocated node; selecting a candidate weighting coefficient group with a smallest rate-distortion cost from the multiple candidate weighting coefficient groups; and taking a first candidate weighting coefficient in the candidate weighting coefficient group with the smallest rate-distortion cost as the first weighting coefficient, and taking a second candidate weighting coefficient in the candidate weighting coefficient group with the smallest rate-distortion cost as the second weighting coefficient.

In a thirty-eighth clause, according to the method of the thirty-seventh clause, the method further includes: signalling the first weighting coefficient and the second weighting coefficient into a bitstream.

In a thirty-ninth clause, according to the method of any one of the twentieth to thirty-eighth clauses, the method further includes: determining an attribute residual value of the current node according to the attribute prediction value of the current node; and generating a bitstream according to the attribute residual value of the current node.

In a fortieth clause, according to the method of the thirty-ninth clause, the attribute prediction value of the current node is a prediction value of an AC coefficient of the current node, and the attribute residual value of the current node is a residual value of the AC coefficient of the current node.

The foregoing are merely specific implementations of the present disclosure, but the protection scope of the present disclosure is not limited thereto. Any person skilled in the art may readily conceive variations or substitutions within the technical scope disclosed by the present disclosure, which should be included within the protection scope of the present disclosure. Therefore, the protection scope of the present disclosure shall be subject to the protection scope of the claims.

What is claimed is:

1. A decoding method, applied to a decoder, comprising:
searching for a first collocated node of a current node in a first reference picture and searching for a second collocated node of the current node in a second reference picture according to geometry information of the current node in a current picture; and
performing inter attribute prediction on the current node according to the first collocated node and the second collocated node, to obtain an attribute prediction value of the current node.

2. The method according to claim 1, wherein performing inter attribute prediction on the current node according to the first collocated node and the second collocated node, to obtain the attribute prediction value of the current node comprises:
in response to the first collocated node being present in the first reference picture and the second collocated node being present in the second reference picture, determining the attribute prediction value of the current node according to an attribute reconstructed value of the first collocated node and an attribute reconstructed value of the second collocated node.

3. The method according to claim 1, wherein performing inter attribute prediction on the current node according to the first collocated node and the second collocated node, to obtain the attribute prediction value of the current node comprises:
in response to the first collocated node being present in the first reference picture and the second collocated node being present in the second reference picture, determining a first difference number between a number of occupied child nodes of the first collocated node and a number of occupied child nodes of the current node according to occupancy information of the first collocated node and occupancy information of the current node;
determining a second difference number between a number of occupied child nodes of the second collocated node and the number of occupied child nodes of the current node according to occupancy information of the second collocated node and the occupancy information of the current node; and
determining the attribute prediction value of the current node according to a relationship between the first difference number and the second difference number.

4. The method according to claim 3, wherein determining the attribute prediction value of the current node according to the relationship between the first difference number and the second difference number comprises:
in response to the first difference number being equal to the second difference number, determining the attribute prediction value of the current node according to an attribute reconstructed value of the first collocated node and an attribute reconstructed value of the second collocated node.

5. The method according to claim 3, wherein determining the attribute prediction value of the current node according to the relationship between the first difference number and the second difference number comprises:
in response to the first difference number being smaller than the second difference number, determining the attribute prediction value of the current node according to an attribute reconstructed value of the first collocated node.

6. The method according to claim 5, wherein
in response to the first difference number being smaller than the second difference number, the attribute prediction value of the current node is equal to the attribute reconstructed value of the first collocated node.

7. The method according to claim 3, wherein determining the attribute prediction value of the current node according to the relationship between the first difference number and the second difference number comprises:
in response to the first difference number being greater than the second difference number, determining the attribute prediction value of the current node according to an attribute reconstructed value of the second collocated node.

8. The method according to claim 7, wherein
in response to the first difference number being greater than the second difference number, the attribute prediction value of the current node is equal to the attribute reconstructed value of the second collocated node.

9. The method according to claim 1, wherein performing inter attribute prediction on the current node according to the first collocated node and the second collocated node, to obtain the attribute prediction value of the current node comprises:
in response to the first collocated node being not present in the first reference picture and the second collocated node being present in the second reference picture, determining the attribute prediction value of the current node according to an attribute reconstructed value of the second collocated node.

10. The method according to claim 9, wherein
in response to the first collocated node being not present in the first reference picture and the second collocated node being present in the second reference picture, the attribute prediction value of the current node is equal to the attribute reconstructed value of the second collocated node.

11. The method according to claim 1, wherein performing inter attribute prediction on the current node according to the first collocated node and the second collocated node, to obtain the attribute prediction value of the current node comprises:
in response to the first collocated node being present in the first reference picture and the second collocated node being not present in the second reference picture, determining the attribute prediction value of the current node according to an attribute reconstructed value of the first collocated node.

12. The method according to claim 11, wherein
in response to the first collocated node being present in the first reference picture and the second collocated node being not present in the second reference picture, the attribute prediction value of the current node is equal to the attribute reconstructed value of the first collocated node.

13. The method according to claim 1, wherein performing inter attribute prediction on the current node according to the first collocated node and the second collocated node, to obtain the attribute prediction value of the current node comprises:
in response to the first collocated node being not present in the first reference picture and the second collocated node being not present in the second reference picture, determining the attribute prediction value of the current node according to an attribute reconstructed value of at least one neighborhood node of the current node in the current picture.

14. The method according to claim 2, wherein determining the attribute prediction value of the current node according to the attribute reconstructed value of the first collocated node and the attribute reconstructed value of the second collocated node comprises:
performing a weighting operation on the attribute reconstructed value of the first collocated node and the attribute reconstructed value of the second collocated node according to a first weighting coefficient of the attribute reconstructed value of the first collocated node and a second weighting coefficient of the attribute reconstructed value of the second collocated node, to obtain the attribute prediction value of the current node.

15. The method according to claim 14, further comprising:
determining the first weighting coefficient according to an interval between an acquisition time of the current picture and an acquisition time of the first reference picture.

16. The method according to claim 14, further comprising:
determining the second weighting coefficient according to an interval between an acquisition time of the current picture and an acquisition time of the second reference picture.

17. The method according to claim 14, further comprising:
parsing a bitstream to obtain the first weighting coefficient and the second weighting coefficient.

18. The method according to claim 1, wherein the attribute prediction value of the current node is a prediction value of an alternating current (AC) coefficient of the current node; and the method further comprises:
parsing a bitstream to obtain a residual value of the AC coefficient of the current node;
determining a reconstructed value of the AC coefficient of the current node according to the residual value of the AC coefficient of the current node and the prediction value of the AC coefficient of the current node; and
performing an inverse region adaptive hierarchal transform (RAHT) on the reconstructed value of the AC coefficient of the current node, to obtain the attribute reconstructed value of the current node.

19. An encoding method, applied to an encoder, comprising:
searching for a first collocated node of a current node in a first reference picture and searching for a second collocated node of the current node in a second reference picture according to geometry information of the current node in a current picture; and
performing inter attribute prediction on the current node according to the first collocated node and the second collocated node, to obtain an attribute prediction value of the current node.

20. A non-transitory computer-readable storage medium, having a computer program and a bitstream stored thereon, wherein the computer program, when executed by a processor, causes the processor to perform following steps of the encoding method to generate the bitstream:
searching for a first collocated node of a current node in a first reference picture and searching for a second collocated node of the current node in a second reference picture according to geometry information of the current node in a current picture; and
performing inter attribute prediction on the current node according to the first collocated node and the second collocated node, to obtain an attribute prediction value of the current node.
